(19) United States
(12) Patent Application Publication
(10) Pub. No.: US 2007/0029940 A1
(43) Pub. Date: Feb. 8, 2007

(54) Driving method of display device using organic self-luminous element and driving circuit of same

(75) Inventor: Hitoshi Tsuge, Osaka (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd, Minato-ku (JP)

(21) Appl. No.: 11/452,984

(22) Filed: Jun. 15, 2006

(30) Foreign Application Priority Data
Jun. 16, 2005 (JP) 2005-177046
Feb. 10, 2006 (JP) 2006-033304

(51) Int. Cl. G09G 3/10

(52) U.S. Cl. 315/169.3; 315/169.2

(57) ABSTRACT

In the present invention, only in screen display with a low lighting ratio in which low gradation display, which tends to cause writing insufficiency, is often performed, a writing current is multiplied by N to increase a characteristic fluctuation compensation ability of driving and transistors and reduce display unevenness. In addition, the number of frames to which an N-fold electric current is fed is reduced. Consequently, display with influences of an increase in electric power and a decline in a life controlled to a minimum limit is realized.

### BACKGROUND OF THE INVENTION

1. Field of the Invention

The present invention relates to a driving method of a display device using an organic luminous element for driving a display device, which performs gradation display according to an amount of electric current, such as an organic electroluminescence element and a driving circuit of the display device using the organic luminous element.

2. Related Art of the Invention

Since an organic luminous element is a self-luminous element, the organic luminous element advantageously does not require a backlight, which is required in a liquid crystal display device, and has a wide view angle, and is therefore prospective as a display device of the next generation.

Since the organic luminous element is an element that emits light when electric charges are injected into the element, even when the organic luminous element is used as a display device, driving for controlling luminance of the organic luminous element according to an amount of electric current in respective pixels is generally adopted.

A driving system in a display device of an active matrix type is roughly divided into two driving systems. The driving systems are a current driving system in which an electric current corresponding to a gradation is outputted from a source driver and the electric current is held in respective pixel circuits in one frame and supplied to an organic luminous element to perform display and a voltage driving system in which a voltage corresponding to a gradation is outputted from a source driver, the voltage is held in respective pixel circuits in one frame, and, after voltage data is converted into current data, an electric current is supplied to an organic luminous element to perform display.

In the voltage driving system, since voltage data is converted into current data by transistors provided in pixels, luminance fluctuation of the respective pixels due to characteristic fluctuation of the transistors tends to occur. In the current driving system less easily affected by characteristic fluctuation of transistors, it is easier to realize display with less unevenness.

As examples of a driving circuit according to the current driving system, there is an active matrix display device having a pixel circuit of a current copier constitution in FIG. 1 or a current mirror constitution in FIG. 2.

FIG. 1 is a diagram showing a pixel circuit 17 according to the current copier constitution, a source driver 16, and a gate driver 15. FIG. 2 is a diagram showing the pixel circuit 17 according to the current mirror constitution, the source driver 16, and the gate driver 15.

In the pixel circuits shown in FIGS. 1 and 2, a p-type TFT is used. As shown in FIGS. 1 and 2, MOS transistors are used as transistors.

FIGS. 1 and 2 are figures used in embodiments of the present invention.

As a problem of the current driving system, when a current value decreases, an electric current is not written in the pixel circuit because of a stray capacitance present in a source signal line.

As a method of solving this problem, as described in International Publication No. 2005/055183 pamphlet, “voltage precharge” and “current precharge” functions are added to a source driver for outputting an electric current to quickly change a current value of a source signal line in response to a predetermined gradation.

As described in Japanese Patent Application Laid-Open No. 2004-029755, there is a method of multiplying a current value supplied to an organic luminous element by N (N>1) and increasing a writing current value to increase speed of change. In this case, since an increase in luminance due to the increase in the writing current occurs, in order to keep luminance at a predetermined value, a period in which an electric current is fed to an organic luminous element 13 is multiplied by 1/N by the control of a gate signal line 11b shown in FIG. 1 or a gate signal line 11d shown in FIG. 2 to prevent luminance in one frame from changing.

In an arrangement of pixel circuits shown in FIG. 3, in the case in which a driving transistor 12a of a pixel A (17a ) and a driving transistor 12c of a pixel C (17c ) had a characteristic indicated by 41 in FIG. 4 and a driving transistor 12b of a pixel B (17b ) had a characteristic indicated by 42 in FIG. 4, when a current of I1 was supplied to all the pixels and display at identical gradation was performed in the respective pixels, at a small current value of I1 (equal to or lower than 10 nA), an electric current flowing to the organic luminous element 13 was different for each pixel as shown in FIG. 5(B). As a result, a problem in that unevenness was caused in uniform display occurred.

As a characteristic of the driving transistors 12, a source signal line voltage had to be a voltage of V1 in the pixels A and C and had to be a voltage of V2 in the pixel B. However, due to an influence of a source signal line capacitance, the voltage could not change to a predetermined value within writing times of the respective pixels as shown in FIG. 5(A). A voltage higher than V2 was applied in the pixel B. As a result, an electric current decreased. A voltage lower than V1 was applied in the pixel C. As a result, a current value increased. Thus, the problem occurred.

The system for improving writing by precharge is a method of applying, in carrying out voltage precharge, a voltage value for realizing an average black display state of all pixels and changing a potential quicker than normally writing an electric current according to voltage fluctuation of a fixed amount corresponding to a gradation by current precharge from the black display state to near predetermined luminance. It is possible to quickly change a potential to an average voltage value of all the pixels with respect to a display gradation. However, it is impossible to cope with a luminance change due to characteristic fluctuation of the driving transistors 12a and 12b of the respective pixels shown in FIG. 3.

In the system for multiplying a writing current by N, an instant current flowing to the organic luminous element increases N-fold. In an organic luminous element in which deterioration in luminance is accelerated as an amount of electric current increases, there is a problem in that a luminance half-life is reduced.

As shown in FIG. 6, when white display is carried out, a voltage value necessary for the organic luminous element increases as N increases. As a result, it is necessary to lower a voltage at an EL power supply 14b in FIG. 1 or 2 or increase a voltage at an EL voltage supply 14a. Power consumption of a display device using the organic luminous element depends on a product of a potential difference between the EL power supplies 14a and 14b and an average value of electric currents flowing to the organic luminous element 13. Thus, in N-fold driving, there is a problem in that electric power increases as N is increased because, although an average of current values does not change, a potential difference increases.

The present invention has been devised in view of the problems and it is an object of the present invention to provide a driving method of a display device using an organic luminous element and a driving circuit of a display device using an organic luminous element that can reduce display unevenness due to characteristic fluctuation of driving transistors while keeping decline in electric power and a life at a minimum limit.

### SUMMARY OF THE INVENTION

In order to solve the problems, a first invention is a driving method of a display device using an organic luminous element that drives a display device using an organic luminous element, said driving device including,

at least one current source circuit that determines a current output per one gradation,

a current control unit that controls a current value of said current source circuit,

a lighting ratio calculating unit that calculates a lighting ratio of a full screen of a predetermined frame,

an immediately-preceding-frame current scale factor storing unit that stores a current scale factor of a frame immediately preceding said predetermined frame,

a current scale factor calculating unit that calculates an applied current scale factor corresponding to the lighting ratio calculated by said lighting ratio calculating unit, and

an electronic volume control unit that increases and decreases a current value applied according to a first applied current scale factor determined by said current scale factor calculating unit, said driving method of a display device using an organic luminous element including:

when a lighting ratio per one frame is lower than a predetermined value,
determining said first current scale factor with said current scale factor calculating unit; and
applying a predetermined electric current with said electric volume control unit, wherein

at a current scale factor in the case in which the lighting ratio per one frame is lower than the predetermined value, a current value N times, where N is a real number larger than 1, as large as that at the time of usual video display is applied.

A second invention is the driving method of a display device using an organic luminous element in the first invention, wherein said determining comprises: multiplying a gradation value indicated by a video signal in each frame by a predetermined value.

A third invention is the driving method of a display device using an organic luminous element in the first invention, wherein said determining comprises: multiplying a current value of a reference current source for each of display colors prepared for applying a video signal by a predetermined value simultaneously for the respective colors.

A fourth invention is the driving method of a display device using an organic luminous element in the first invention, wherein said predetermined lighting ratio is equal to or lower than 12.5%.

A fifth invention is the driving method of a display device using an organic luminous element in the first invention, wherein a scale factor of said predetermined current is larger than one and equal to or smaller than four.

A sixth invention is the driving method of a display device using an organic luminous element in the first invention, wherein an application time of a current signal to said organic luminous element at the time when a current value multiplied by N, which is said predetermined current scale factor, is applied to said organic luminous element constituting each pixel of the display device using said organic luminous element is represented as 1/N(t), which is 1(t) when N is 1.

A seventh invention is the driving method of a display device using an organic luminous element in the first invention, wherein

said display device using the organic luminous element includes:

at lest one current source circuit that determines a current output per one gradation;

a current control unit that controls a current value of said current source circuit;

a current scale factor calculating unit that multiplies an applied current scale factor; and

an electronic volume control unit that increases and decreases a current value applied according to a second applied current scale factor determined by said current scale factor calculating unit, and

said driving method of a display device using an organic luminous element includes:

applying, in a predetermined period, a predetermined electric current determined according to said second applied current scale factor to each pixel; and

applying, after the predetermined period passes, a predetermined electric current determined according to said first applied current scale factor.

An eighth invention is a driving method of a display device using an organic luminous element, said display device including,

at least one current source circuit that determines at least a current output per one gradation,

a current control unit that controls a current value of said current source circuit, and

a precharge unit that applies a predetermined electric signal before applying a video signal, precharge signal values corresponding to respective display gradations at the time of onefold driving, which is normal driving, being stored in said precharge unit,

said driving method of a display device using an organic luminous element including: using, in displaying a gradation M, where M is an integer equal to or larger than 0, with a current value applied to the display device using the organic luminous element set to N times, where N is a real number to or larger than 1, as large as that at the time of normal driving, a value calculated by multiplying said precharge signal stored by 1/N as a precharge current and carrying out precharge in a period calculated by multiplying a usual precharge period by N/M.

A ninth invention is the driving method of a display device using an organic luminous element in the seventh invention, wherein an electric signal for performing said precharge is an electric current.

A tenth invention is the driving method of a display device using an organic luminous element in the eighth invention, wherein an electric signal for performing said precharge is an electric current.

An eleventh invention is a driving circuit of a display device using an organic luminous element, including:

at least one current source circuit that determines a current output per one gradation;

a current control unit that controls a current value of said current source circuit;

a lighting ratio calculating unit that calculates a lighting ratio of a full screen in a predetermined frame;

an immediately-preceding-frame current scale factor storing unit that stores a current scale factor of a frame immediately preceding said predetermined frame;

a current scale factor calculating unit that calculates an applied current scale factor corresponding to the lighting ratio calculated by said lighting ratio calculating unit; and

an electronic volume control unit that increases and decreases a current value applied according to an applied current scale factor determined by said current scale factor calculating unit, wherein

the current scale factor calculating unit determines a current value N times (N is a real number larger than 1) as large as that at the time of usual video display.

According to the driving method of a display device using an organic luminous element and the driving circuit of a display device using an organic luminous element of the present invention, there is an effect that display unevenness due to characteristic fluctuation of driving transistors is reduced while decline in electric power and a life is kept at a minimum limit.

### BRIEF DESCRIPTION OF THE DRAWINGS

FIG. 1 is a diagram showing a pixel circuit, a source driver, and a gate driver according to a current copier constitution in first to third embodiments of the present invention;

FIG. 2 is a diagram showing a pixel circuit, a source driver, and a gate driver according to a current mirror constitution in the first to the third embodiments of the present invention;

FIG. 3 is a diagram showing a circuit structure at the time when pixel transistors 12 having characteristics indicated by 41 and 42 in FIG. 4 are arranged in pixels of on an identical signal line;

FIG. 4 is a graph indicating that gate voltages are different even when an identical drain current flows because of characteristic fluctuation of the driving transistors 12;

FIG. 5(A) is a graph showing a relation between a source signal line voltage in writing a current in three pixels at the time when a display device shown in FIG. 3 is driven and an identical electric current is outputted to a source signal line, and a current value flowing to an organic luminous element at that time, and the graph showing a relation between time and voltage on a source signal line 10;

FIG. 5(B) is a graph showing a relation between a source signal line voltage in writing a current in three pixels at the time when a display device shown in FIG. 3 is driven and an identical electric current is outputted to a source signal line, and a current value flowing to an organic luminous element at that time, and the graph showing a relation between time and a current value flowing to an organic luminous element 13;

FIG. 6 is a graph showing a relation between a current scale factor at the time of white gradation display and a voltage necessary for an organic luminous element;

FIG. 7 is a graph showing a relation between a writing current scale factor according to a difference of lighting ratios and a rate of a light emission period in an embodiment of the present invention;

FIG. 8 is a diagram showing an example of an output stage of a current output type source driver in the first and the second embodiments of the present invention;

FIG. 9 is a graph showing changes at the time when a gradation signal scale factor and a rate of a light emission period are changed according to a lighting ratio in the first embodiment of the present invention;

FIG. 10(A) is a graph showing a relation of source driver output gradations to input data at a lighting ratio lower than 1% in the first embodiment of the present invention;

FIG. 10(B) is a graph showing a relation of source driver output gradations to input data at a lighting ratio of 8% in the first embodiment of the present invention;

FIG. 10(C) is a graph showing a relation of source driver output gradations to input data at a lighting ratio equal to or higher than 12.5% in the first embodiment of the present invention;

FIG. 11 is a diagram showing operations in the case in which a period in which an EL element emits light is changed according to a gate signal line 2 in the first embodiment of the present invention;

FIG. 12 is a diagram showing a circuit block for changing a driver output gradation according to a lighting ratio with respect to input data and controlling a light emission period according to the change in the first embodiment of the present invention;

FIG. 13(A) is a graph showing a relation between input data and a drive output gradation in the case in which a lighting ratio is lower than 1 percent in the first and the second embodiment of the present invention;

FIG. 13(B) is a graph showing a relation between input data and a driver output gradation in the case in which a lighting ratio is 8 percent in the first and the second embodiments of the present invention;

FIG. 13(C) is a graph showing a relation between input data and a driver output gradation in the case in which a lighting ratio is equal to or higher than 12.5 percent in the first and the second embodiments of the present invention;

FIG. 14 is a diagram showing a relation between a reference current generating unit and output stages of respective colors in the second embodiment of the present invention;

FIG. 15 is a diagram showing a circuit structure that can change a reference current regardless of a display color in the second embodiment of the present invention;

FIG. 16(A) is a graph showing a relation between a lighting ratio and a reference current in the case in which driving for changing a reference current according to a lighting ratio is carried out in the second embodiment of the present invention;

FIG. 16(B) is a graph showing a relation between a lighting ratio and a light emission period in the case in which driving for changing a reference current according to a lighting ratio is carried out in the second embodiment of the present invention;

FIG. 17 is a graph showing a relation between a source signal line voltage generated by the driving transistors 12 and a current value in the case in which an electric current is written in a relevant pixel in the second embodiment of the present invention;

FIG. 18 is a diagram showing a circuit structure with one output of a source driver that has a precharge current value changing function in the second embodiment of the present invention;

FIG. 19 is a table showing operations of a switching unit 183 in FIG. 18 in the second embodiment of the present invention;

FIG. 20 is a table showing a relation of a precharge current value control signal to a reference current scale factor in the second embodiment of the present invention;

FIG. 21 is a diagram showing a circuit structure of a source driver including an output stage shown in FIG. 18 and having a function that can change a reference current of all output stages in the second and the third embodiments of the present invention;

FIG. 22 is a diagram showing a structure of a judging circuit for changing a reference current according to a lighting ratio in the second embodiment of the present invention;

FIG. 23 is a diagram showing a flow of judgment by a precharge judging unit in FIG. 22 in the second embodiment of the present invention;

FIG. 24(A) is a graph showing a state of a potential change of an EL power supply 14b with respect to a reference current scale factor due to a difference of lighting ratios and showing a relation between a lighting ratio and an electric current flowing through a resistor 144 in the second embodiment of the present invention;

FIG. 24(B) is a graph showing a state of a potential change of the EL power supply 14b with respect to the reference current scale factor due to a difference of lighting ratios and showing a relation between a lighting ratio and a power supply voltage of the EL power supply 14b in the second embodiment of the present invention;

FIG. 25 is a graph showing changes in a reference current scale factor, a rate of a light emission period, a gradation output for precharge current, a data scale factor for precharge judgment, and a cathode voltage according to a lighting ratio in the second embodiment of the present invention;

FIG. 26 is a diagram in which a display device in an embodiment of the present invention is built in a digital camera in the third embodiment of the present invention;

FIG. 27(A) is a graph showing a way of changing a reference current scale factor in response to a shutter switch 263 operation and showing a relation between the shutter switch 263 operation and the reference current scale factor in the third embodiment of the present invention;

FIG. 27(B) is a graph showing a way of changing a reference current scale factor in response to the shutter switch 263 operation and showing a relation between the shutter switch operation and a light emission period rate in the third embodiment of the present invention;

FIG. 28(A) is a graph showing a way of changing a reference current scale factor in response to a shutter switch 263 operation and showing a relation between the shutter switch 263 operation and the reference current scale factor in the third embodiment of the present invention;

FIG. 28(B) is a graph showing a way of changing a reference current scale factor in response to the shutter switch 263 operation and showing a relation between the shutter switch operation and a light emission period rate in the third embodiment of the present invention;

FIG. 29(A) is a graph showing a change in a reference current scale factor due to a difference of a lighting ratio at the time of usual display and in the case in which an image is displayed at luminance twice as high as usual luminance in the third embodiment of the present invention;

FIG. 29(B) is a graph showing a change in the light emission period rate due to a difference of a lighting ratio at the time of usual display and in the case in which an image is displayed at luminance twice as high as usual luminance in the third embodiment of the present invention;

FIG. 30 is a diagram showing a current copier constitution in the case in which a pixel circuit is constituted by an n-type TFT in the first to the third embodiments of the present invention; and

FIG. 31 is a diagram showing an output stage structure of a current output source driver of a discharge type in the first to the third embodiments of the present invention.

### DESCRIPTION OF SYMBOLS

10, 10a, 10b Source signal lines
11b Gate signal line
11d Gate signal line
12, 12a, 12b, 12c Driving transistors
13, 13a, 13b, 13c Organic luminous elements
14 EL power supply
14a EL power supply
14b EL power supply
17 Pixel
17a Pixel A
17b Pixel B
18c Pixel C
Storage capacitor
80a, 80b, 80c, 80d, 80e, 80f Control signal for switching unit 146
81 Reference current generating unit
82 Current source
82a, 82b, 82c, 82d, 82e, 82f, 82g, 82h
83 Output line
85a, 85b, 85c, 85e, 85f, 85f
86 Current precharge control line
87 Current output unit
120 Gamma correction circuit
121 Video signal after gamma correction
122 Precharge judgment signal generating unit
123 Gradation level converting unit
124 Lighting ratio data
128 Lighting ratio calculating unit
129 Command input
141a, 141b, 141c, 141d, 141e, 141f Current outputs
142a, 142b, 142c Electronic volume control signals
142d Electronic volume control signal
143a, 143b, 143c, 143d Electronic volumes
144 Resistor
144a, 144b, 144c Resistors
181 Current output unit
182 Current precharge period control line
184 Precharge current value control signal
185 Output stage
186 Current precharge pulse group 186a, 186b, 186c
187 Voltage precharge pulse group
222 Current scale factor calculating unit
223 Precharge current calculating unit
224 Data calculating unit
225 Precharge judging unit
227 Scale factor data
228 Voltage control unit
291 Area with lighting ratio equal to or lower than 12.5%

### PREFERRED EMBODIMENTS OF THE INVENTION

Embodiments of the present invention will be hereinafter explained with reference to the drawings.

In order to reduce display unevenness due to characteristic fluctuation of driving transistors 12, essentially, it is preferable to perform display in a current driving system in which uniform display is possible even if there is fluctuation in characteristics of the driving transistors 12.

Display unevenness occurs in the current driving system because, as explained earlier, when a writing current value is small, it is difficult to change a source signal line potential. Conversely, when a writing current value is large, it is possible to perform display without display unevenness even if a writing current is not increased N-fold.

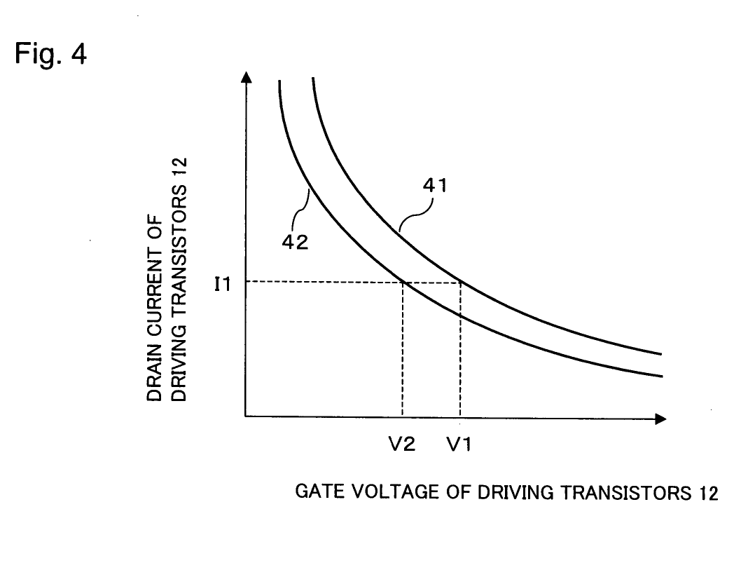

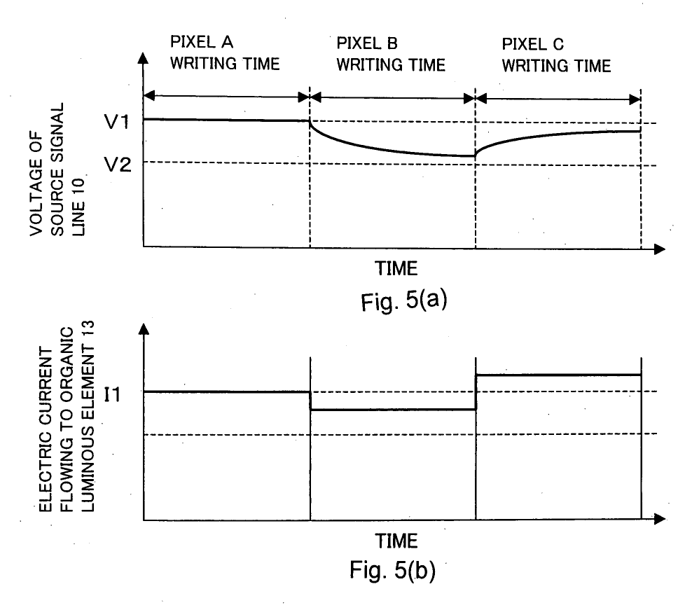

Therefore, in principle, even if here is characteristic fluctuation of driving transistors shown in FIG. 4, a source signal line potential changes and, in a gradation for feeding a source signal line current from which an identical electric current is written in all pixels, an electric current of onefold is written and, in gradations lower than the gradation, a current value is increased N-fold. This makes it possible to perform uniform display. Power consumption is increased only by pixels in which an electric current is written with the N-fold current value.

In this case, in white display, since it is possible to perform writing with which an identical electric current is written in all the pixels, the electric current of one fold is sufficient. Therefore, in the white display, there is no increase in electric power. On the other hand, in one-gradation display, since writing is performed with an N-fold current, the display unevenness is improved. Electric power in the one-gradation display increases by, for example, a degree equivalent to a 30% increase in a potential difference because of the writing with an N-fold current. An electric current flowing to an organic luminous element in the one-gradation display is 1/255 with respect to that in the white display when a writing current is not increased N-fold. When a writing current is increased N-fold in the one-gradation display, even if electric power increases, the electric power is 0.5% of electric power in the white display. Therefore, even if a writing current is increased N-fold in the one-gradation display, there is no problem because an amount of increase in electric power is not affected much and it is not necessary to increase a power supply capacitance.

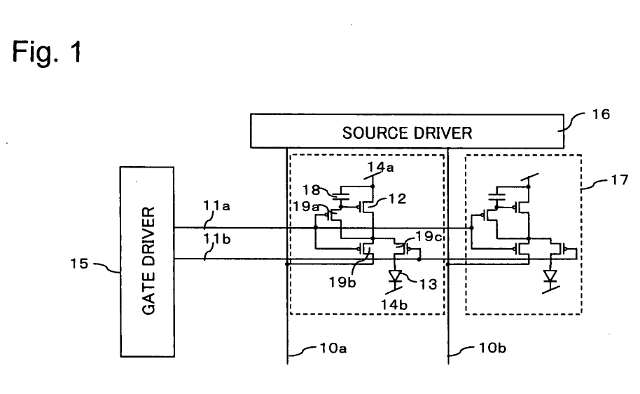

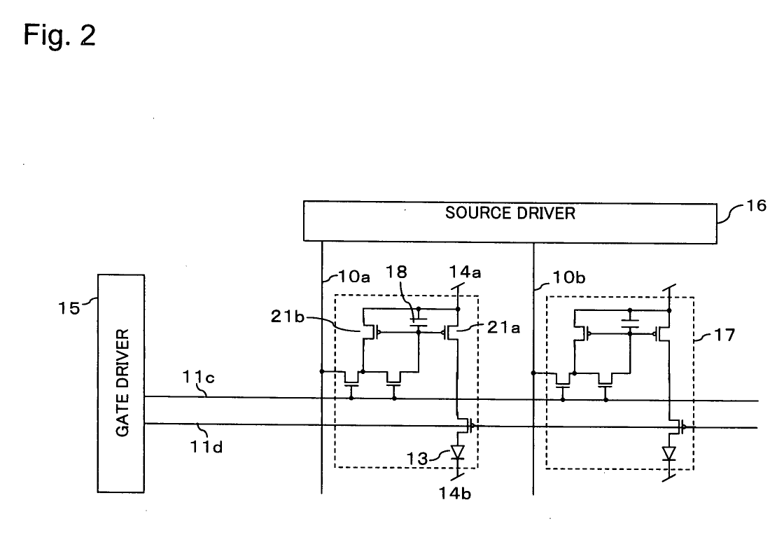

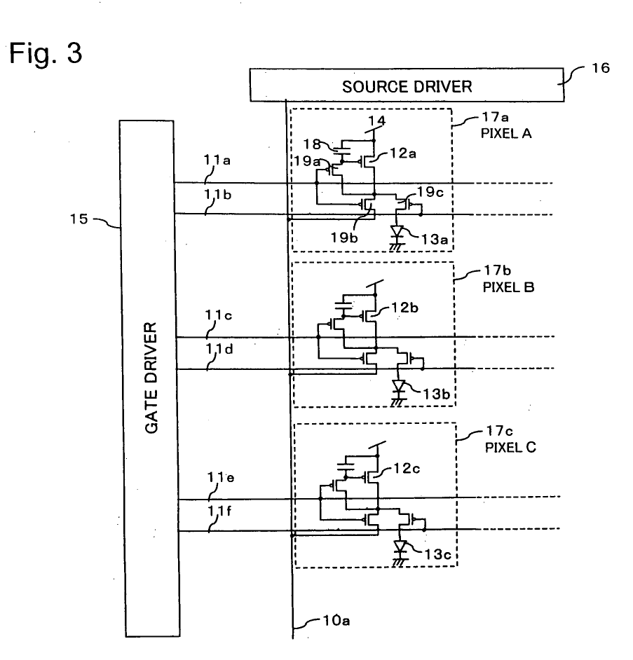

However, in an active matrix display device, light emission periods of respective pixels are controlled by a gate driver with a shift register constitution. Therefore, it is difficult to control light emission time according to a gradation, or control light emission time for each pixel. In order to realize the control of light emission time for each pixel, it is suitable to prepare the gate signal line 11b shown in FIG. 1 or the gate signal line lid shown in FIG. 2 by the number of pixels and a control unit that controls respective signals is required. Consequently, wiring and circuit sizes are substantially large. Therefore, it is difficult to lay out the gate signal lines 11b and 11d by the number of pixels and lay out the control unit on an array substrate.

Thus, in the embodiments of the present invention, a system for calculating a sum of display data of all pixels and increasing a writing current N-fold for all the pixels on the basis of data (hereinafter, “lighting ratio”) normalized to be 100% when maximum luminance is displayed on a full screen and to be 0% when minimum luminance is displayed on the full screen is devised. As an equation for calculating a lighting ratio, it is possible to calculate a lighting ratio with an equation of (a sum of display data of entire one frame)/(a sum of display data in the case in which all pixels display maximum gradation)×100.

For example, the embodiments of the present invention adopts a method of performing N-fold driving (N>1) when a lighting ratio is equal to or lower than 12.5% and performing onefold driving (usual driving) when a lighting ratio is larger than 12.5%. In general, a lighting ratio is lower as the number of pixels of low gradation in which display unevenness tends to occur is larger. The lighting ratio is higher as the number of pixels of high gradation in which display unevenness does not tend to occur is larger. Therefore, changing a value of N of the N-fold driving according to the lighting ratio is substantially synonymous with driving for increasing a value of N only in pixels with a low gradation in which display unevenness tends to occur.

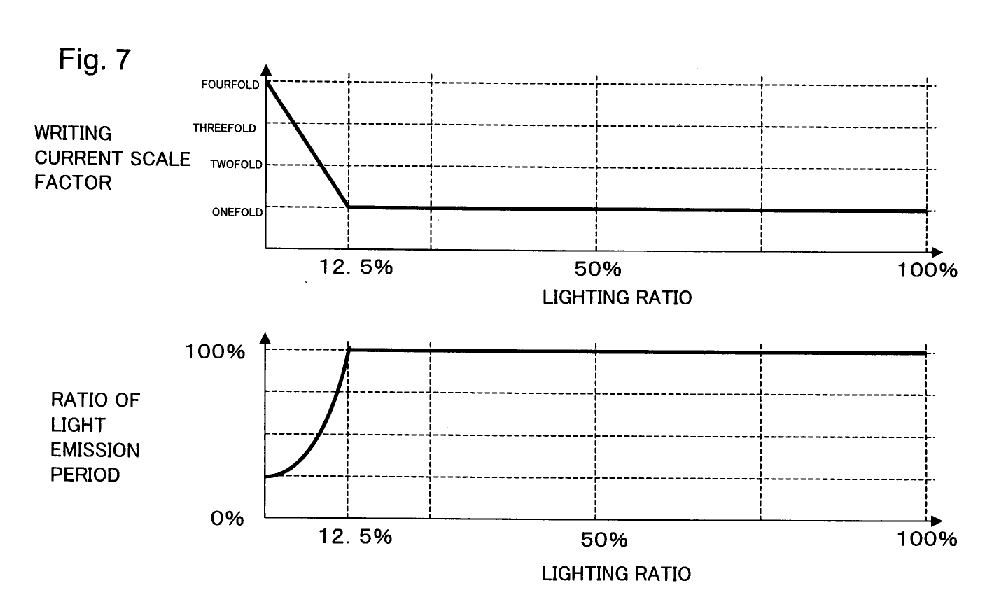

Therefore, in the embodiments of the present invention, a value of N of an N-fold electric current (N≧1) is changed on the basis of a lighting ratio rather than a display gradation and a lighting period is multiplied by 1/N (N≧1) in association with the change. A relation among a writing current, a light emission period, and a lighting ratio is shown in FIG. 7. In a figure on an upper side of FIG. 7, an abscissa indicates the lighting ratio and an ordinate indicates a writing current scale factor, that is, a value of N of N-fold driving. In a figure on a lower side of FIG. 7, an abscissa indicates the lighting ratio and an ordinate indicates a rate of the light emission period.

Since easiness of occurrence of display unevenness is different depending on a writing current value, it is suitable to increase the scale factor (or increase the value of N of an N-fold electric current) as a writing current is smaller. Therefore, as shown in FIG. 7, the lighting ratio is equal to or lower than 12.5% and, as the lighting ratio decreases, a scale factor of the writing current is gradually increased.

A lighting ratio for increasing the scale factor may be set to an arbitrary value rather than 12.5%. However, when the lighting ratio is too high, N-fold driving is performed in most display images. Thus, there is little advantage in terms of electric power and a life compared with the conventional N-fold driving. In general, data displayed as a video signal is often display data with a lighting ratio of about 25 to 35%. In the N-fold driving with a lighting ratio equal to or lower than 12.5%, there is an advantage that display, which is substantially the same as the conventional onefold current writing in terms of electric power and a life, is obtained in the aspect of practical uses.

A method for increasing a writing current N-fold will be described. In the embodiments of the present invention, roughly, two systems are devised. The two systems will be explained in order.

### First Embodiment

First, a first system for increasing a writing current N-fold will be explained in a first embodiment. Components identical with those explained above are denoted by the identical reference numerals and signal. Detailed explanations of the components are omitted.

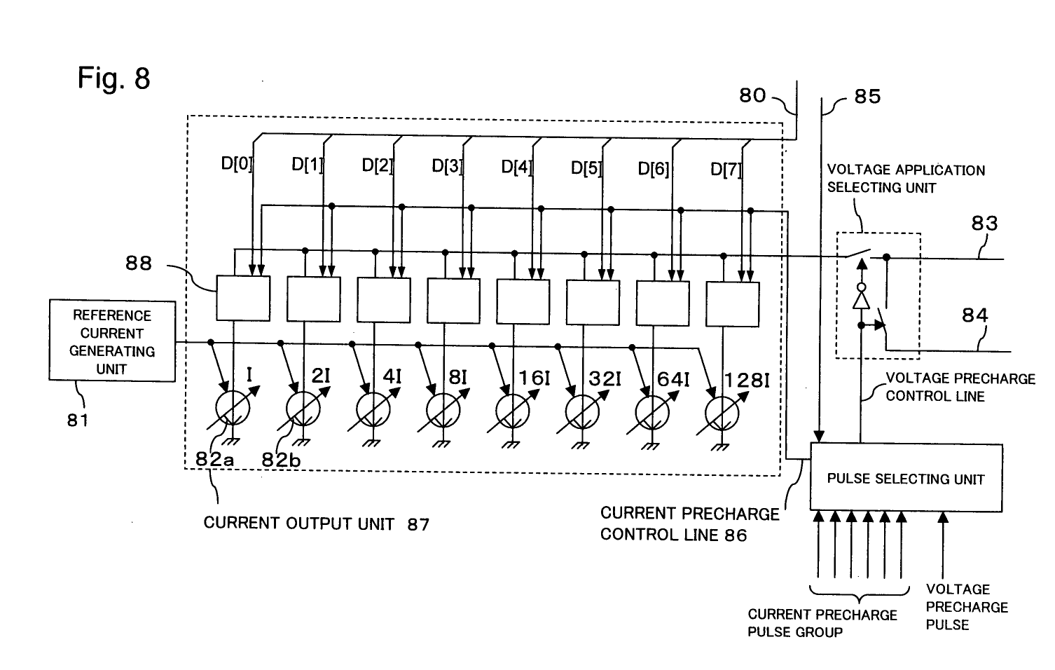

An example of a structure of an output stage of a current output type source driver is shown in FIG. 8.

In the source driver that performs current output, as shown in FIG. 8, current sources 82 (which means 82a, 82b, and the like in FIG. 8) are prepared by the number of bits as the structure of the output stage. Outputs of the respective current sources 82 are varied such that the respective current sources 82 output electric currents corresponding to weights of the bits.

As shown in FIG. 8, in a least significant bit, a current source 82a with a current output of I is provided. In higher order bits, current sources with current outputs twice as large as that of the preceding current sources are provided, respectively. In a most significant bit, an electric current of 128I flows to a current source (I indicates an amount of electric current per one gradation. Since a current output corresponding to a weight of a bit is obtained with respect to arbitrary I, current outputs are represented by I to 128I).

I indicates an electric current per one gradation. A reference current generating unit 81 determines a value of this electric current.

A switching unit 88 is present in order to perform current output corresponding to a gradation. When a high-level signal is sent in response to video data 80, the switching unit 88 comes into a conduction state and an electric current corresponding to a gradation is outputted from an output line 83. Therefore, the current output is in a proportional relation to a display gradation.

As shown in FIG. 8, a current source of a source driver is a type of current source that draws an electric current from the outside.

The applicant considered increasing a writing current N-fold by increasing a video signal N-fold using the current source. For example, when a gradation 1 at the time of twofold driving is displayed, a gradation 2 is outputted from the source driver. Consequently, a twofold electric current flows.

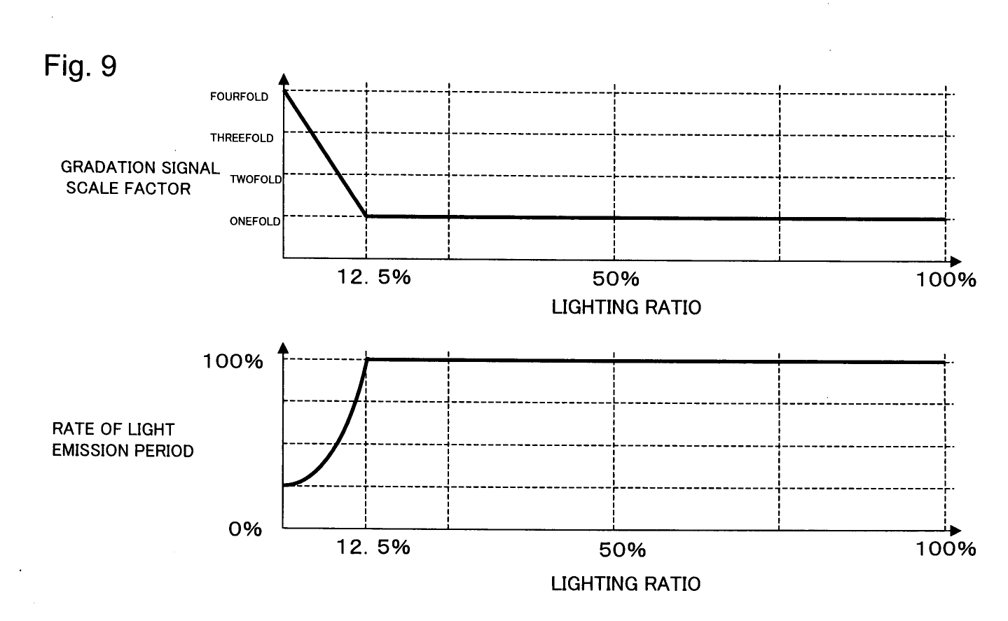

As in FIG. 7, if a signal scale factor is changed as shown in FIG. 9, the same effects as those in FIG. 7 are obtained. FIG. 9 is a graph showing a change at the time when a gradation signal scale factor and a rate of a light emission period are changed according to a lighting ratio. In a figure on an upper side of FIG. 9, an abscissa indicates the lighting ratio and an ordinate indicates the gradation scale factor. In a figure on a lower side of FIG. 9, an abscissa indicates the lighting ratio and an ordinate indicates the ratio of a light emission period.

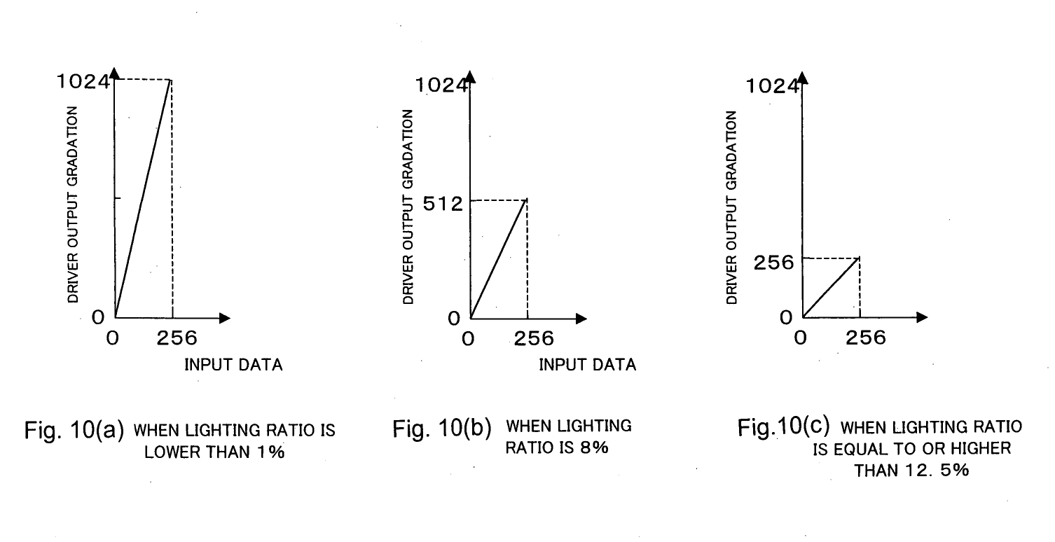

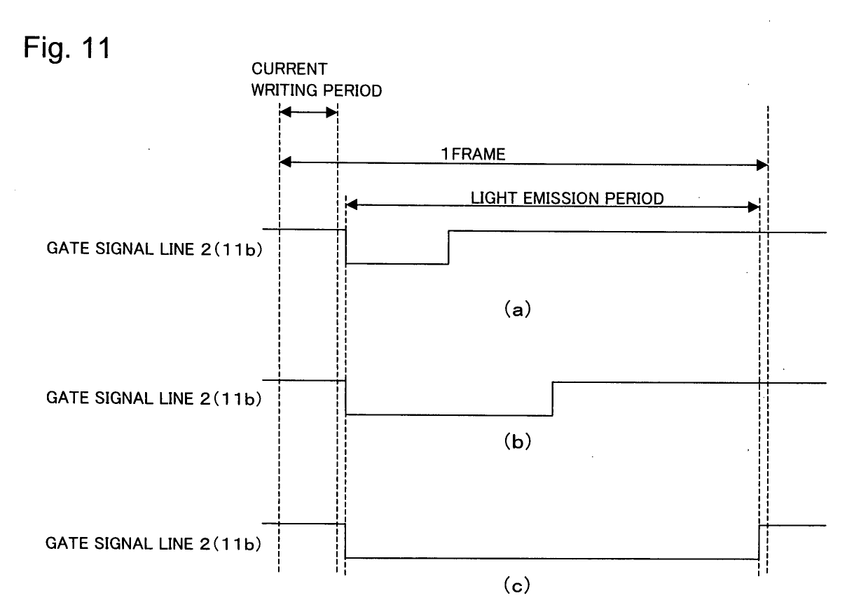

Relations of driver output gradations to input video signals at the time when the lighting ratio is lower than 1%, 8%, and equal to or higher than 12.5% are shown in FIGS. 10(A), 10(B), and 10(C), respectively. Relations of light emission periods corresponding to FIGS. 10(A) to 10(C) are shown in FIG. 11(A) to 11(C).

In the first embodiment of the present invention, video signal data is changed according to a lighting ratio and inputted to a driver.

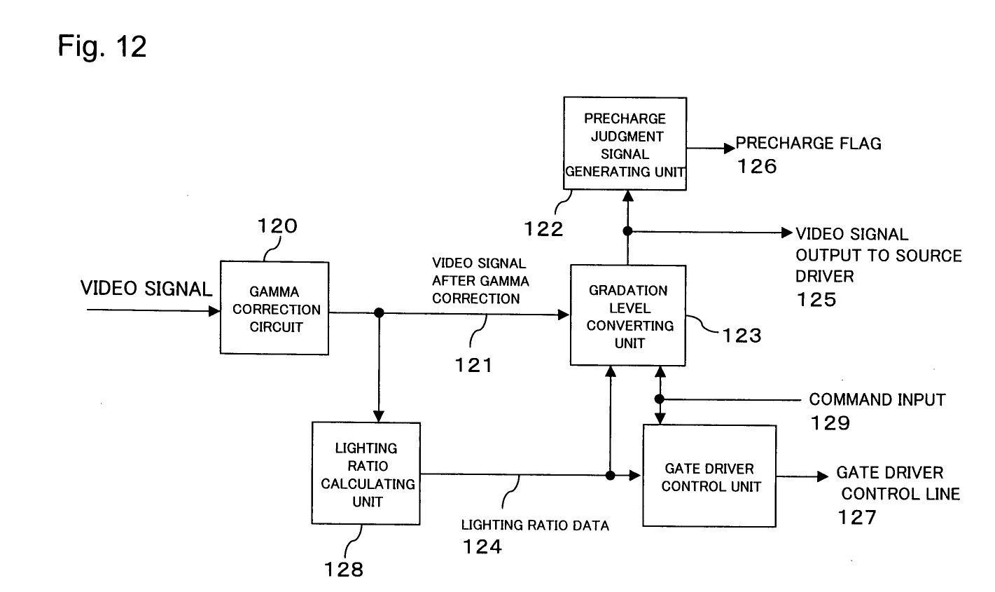

A circuit block for changing a driver output gradation with respect to input video signal data according to a lighting ratio and controlling a light emission period according to the change is shown in FIG. 12.

The circuit block in FIG. 12 includes a gamma correction circuit 120, a lighting ratio calculating unit 128, a precharge judgment signal generating unit 122, a gradation level converting unit 123, and a gate driver control unit. Reference numeral 125 denotes an output to the source driver and reference numeral 127 denotes a gate driver control line.

As shown in FIG. 12, a gradation level converting unit 123 is inserted in a post stage of the gamma correction circuit 120. The gradation level converting unit 123 performs level conversion of a post-gamma-correction video signal 121 according to a value of lighting ratio data 124, which is a calculation result of the lighting ratio calculating unit 128. Relations of this level conversion are the relations shown in FIGS. 10(A), 10(B), and 10(C).

A command input 129 is used to change a curve of the relation between a scale factor and a lighting ratio shown in FIG. 9. The command input 129 makes it possible to set a maximum scale factor and a gradation signal ratio by changing a value of the lighting ratio that increases from a onefold ratio.

The precharge judgment signal generating unit 122 judges length of precharge and on/off of precharge on the basis of an output of the gradation level converting unit 123. The precharge judgment signal generating unit 122 performs the judgment on the basis of an output of the gradation level converting unit 123 because it is necessary to perform the judgment on length of precharge and on/off on the basis of an electric current actually outputted to a panel. In other words, the precharge judgment signal generating unit 122 performs the judgment in order to carry out the judgment on the basis of a video signal output to the source driver.

In order to carry out the relations shown in FIGS. 10(A), 10(B), and 10(C), which are driving for feeding a maximum fourfold electric current when a lighting ratio is low, the number of gradations of a driver four times as large as the number of input display gradations is required. A circuit size of an output stage of the driver increases.

Thus, as a modification in the first embodiment of the present invention, a case in which the circuit size of the output stage of the driver does not increase will be explained.

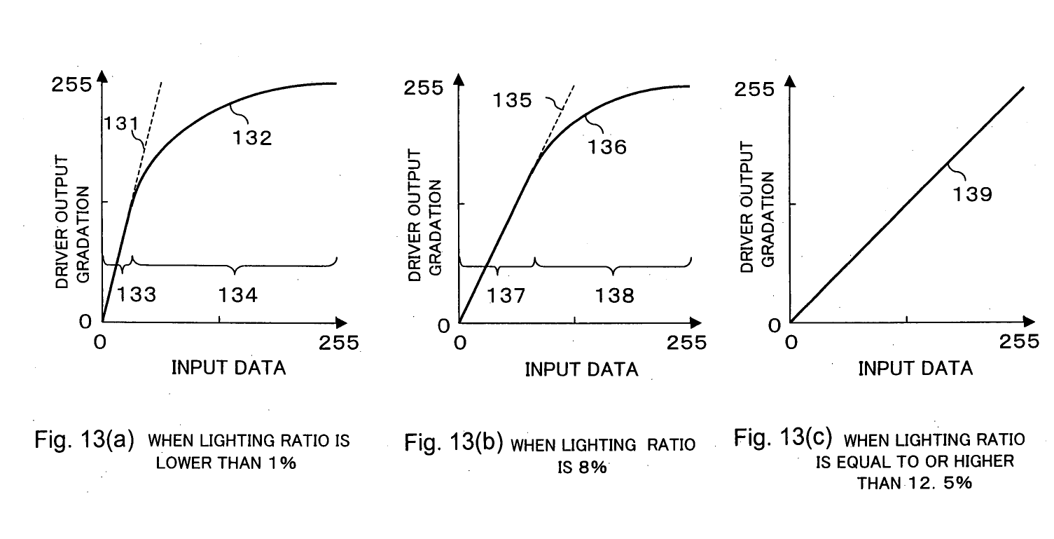

As the gradation level converting unit 123 shown in FIG. 12, in order to obtain the same effects as the driving shown in FIG. 9 with the number of output gradations of the driver identical with the number of input gradation data, a gradation level converting unit 123 having relations between input data and driver output corresponding to lighting ratios shown in FIGS. 13(A), 13(B), and 13(C) is provided.

In this case, as shown in FIG. 13(C), it is possible to display an image at predetermined luminance with respect to all gradations when a lighting ratio is equal to or higher than 12.5%. However, in gradations in which a data scale factor does not correspond to a change in a rate of a light emission period in FIGS. 13(A) and 13(B), a writing current does not increase sufficiently with respect to a reduction in the light emission period and luminance falls. Ranges of input data indicated by 134 and 138 correspond to this. 131 shown in FIG. 13(A) and 135 shown in FIG. 13(B) are lines indicating a case in which the number of gradations of the driver is increased to be larger than the number of gradations of the input data. The lines are shown for reference. A range of 133 shown in FIG. 13(A) and a range of 137 shown in FIG. 12(B) indicate ranges of the input data in which the data scale factor corresponds to the change in the rate of the light emission period.

However, when a lighting ratio is low, it is considered that the number of pixels that perform high-gradation display is small. It is possible that data of the ranges indicated by 134 and 138 is not present in one screen. Even if the data is present, the data is present only at a few points. Decline in luminance is not conspicuous with respect to screen display. Therefore, even in the relations between input data and driver output gradations shown in FIGS. 13(A), 13(B), and 13(C), it is possible to perform display with deterioration in an image quality controlled.

As a scale factor of the input data is increased, the number of gradations for performing output at a predetermined scale factor with respect to the input data decreases. Thus, it is assumed that the number of pixels, in which decline in luminance occurs, increases. Therefore, it is desirable to limit the scale factor of the input data to about four times at the maximum.

### Second Embodiment

A second system for increasing a writing current N-fold will be explained in a second embodiment. Components identical with those explained above are denoted by the identical reference numerals and signs. Detailed explanations of the components are omitted.

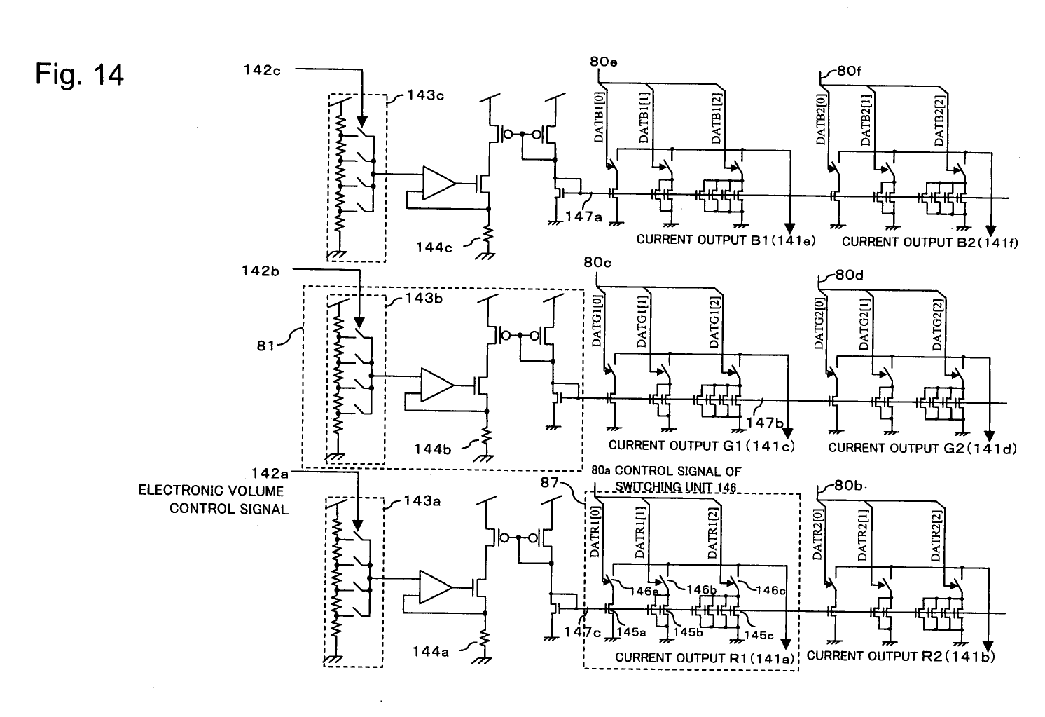

FIG. 14 is a diagram showing a relation between a reference current generating unit and output stages of respective colors. As shown in FIG. 14, MOS transistors are used as transistors.

In a current output type driver, a current output stage has a structure shown in FIG. 14. In this case, a gradation depends on the number of transistors connected to an output. An electric current per one gradation depends on a current value flowing to resistors 144 (which mean resistors denoted by 144a, 144b, and 144c in FIG. 14). This is because an electric current flowing to the resistors 144 is transmitted to respective current sources for gradation display of respective outputs by a current mirror constitution. A current value per one gradation with respect to the electric current to the resistors 144 depends on a channel size ratio of transistors constituting a current mirror. The electric current increases and decreases in a proportional relation.

It is possible to output an N-fold writing current from a source driver by increasing an electric current flowing to the resistors 144 (hereinafter referred to as reference current) N-fold. It is possible to change the reference current using electronic volumes 143a to 143c. However, the electronic volumes are used for adjusting luminance fluctuation due to efficiency fluctuation of respective colors of an organic luminous element. In order to increase an electric current N-fold with respect to respective set current values, an arithmetic circuit for a resistor value for increasing resistor values of the respective colors after adjustment N-fold is required. Thus, a circuit size increases. Since arithmetic circuits are required for the respective colors, arithmetic circuits for three circuits are required. In this regard, it is disadvantageous in that a circuit size increases.

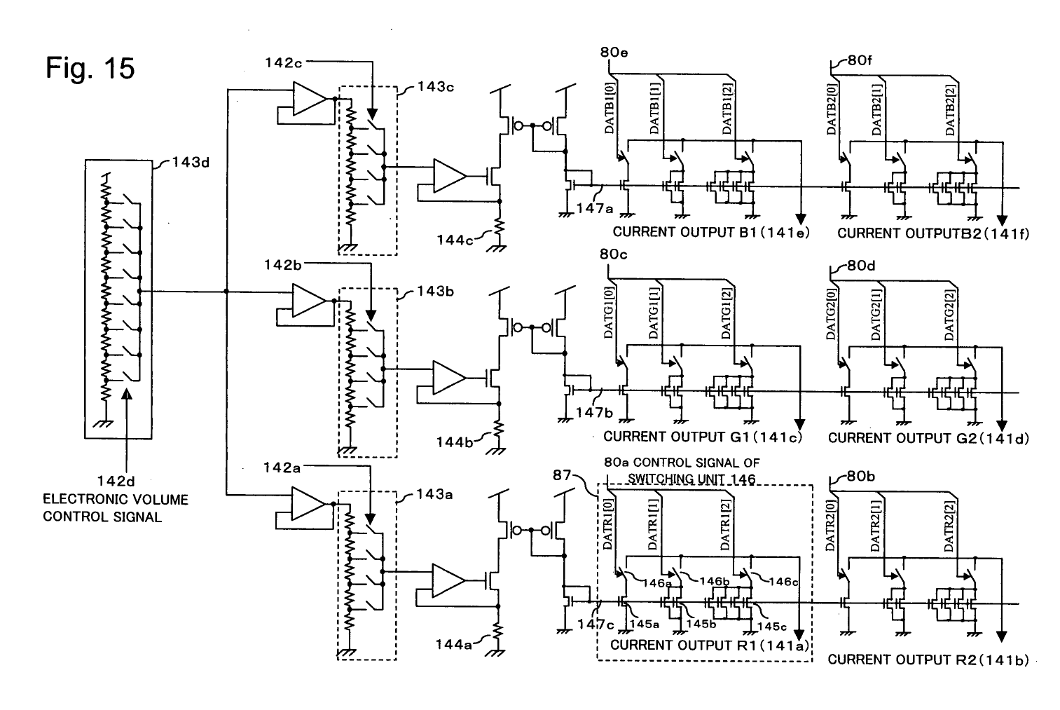

Thus, in the second embodiment of the present invention, as shown in FIG. 15, an electronic volume for increasing a current value N-fold for the respective colors in common is further provided in addition to the structure in FIG. 14. In FIG. 15, the electronic volume for increasing a current value N-fold for the respective colors in common is shown as an electronic volume 143d. As shown in FIG. 15, MOS transistors are used as transistors.

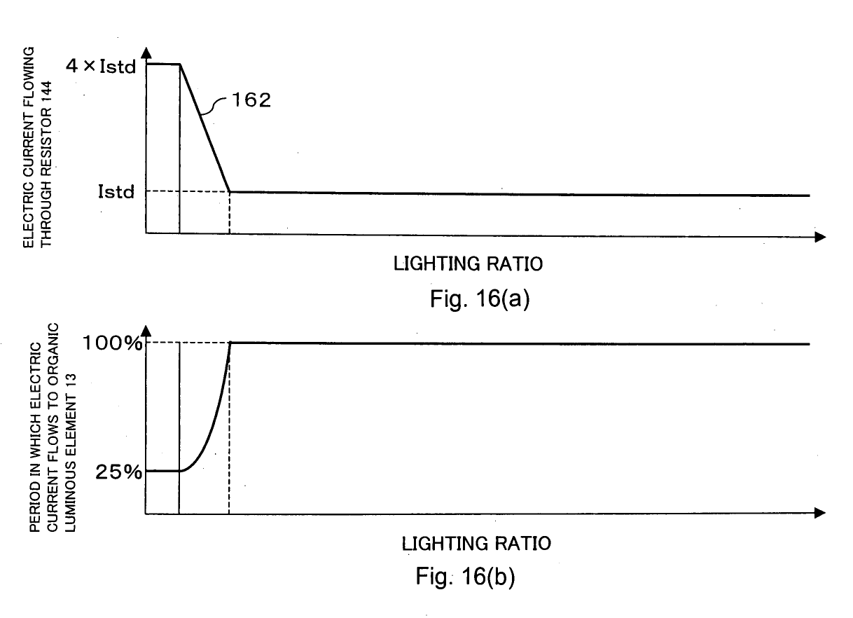

If a current increase rate by resistance division of an electronic volume 143d is designed to be onefold to four fold points as shown in FIG. 16(A) with an electronic volume at the time when a onefold electric current flows as a minimum value, it is possible to uniquely determine an electronic volume without calculating the electronic volume value with respect to a designated scale factor. Thus, it is possible to constitute a circuit that realizes N-fold driving without requiring an arithmetic circuit.

Concerning an electronic volume circuit unit, from the viewpoint of white balance adjustment, the electronic volumes 143a to 143c have to carry out the change of an amount of electric current per one stage at a stride of 1% to about 2% at the maximum. In order to change a fourfold electric current, adjustment in 150 stages is necessary. To realize this, an 8-bit electronic volume circuit is required (since this electronic volume circuit is required for each color, three circuits are required in total).

On the other hand, in the case of the structure in FIG. 15 in which the common electronic volume 143d is provided, since there is no limitation concerning a stride, even if a fourfold current changing function is provided in the electronic volume 143d, the electronic volume 143d may be, for example, a 2-bit electronic volume in four stages (onefold, twofold, threefold, and fourfold). An electronic volume circuit depends on how many kinds of current scale factor, which can be taken on a line indicated by 162 in FIG. 16, can be given. In the electronic volume 143d, since a current difference equal to or larger than 2% does not cause a problem, the electronic volume 143d only has to have about six bits at the maximum. In terms of a total area of the electronic volume unit 143, it is suitable to use the four electronic volumes 143a to 143d shown in FIG. 15.

If one electronic volume circuit is added as shown in FIG. 15 and a value of the electronic volume 143d is controlled to have a current increase rate shown in FIG. 16, it is possible to increase a writing current value. However, in a driver circuit having a current precharge function, there is a problem in that a luminance fall or a luminance increase occurs in pixels, in which current precharge is carried out, because of deviation of a precharge amount involved in a change in the reference current and a display quality is deteriorated.

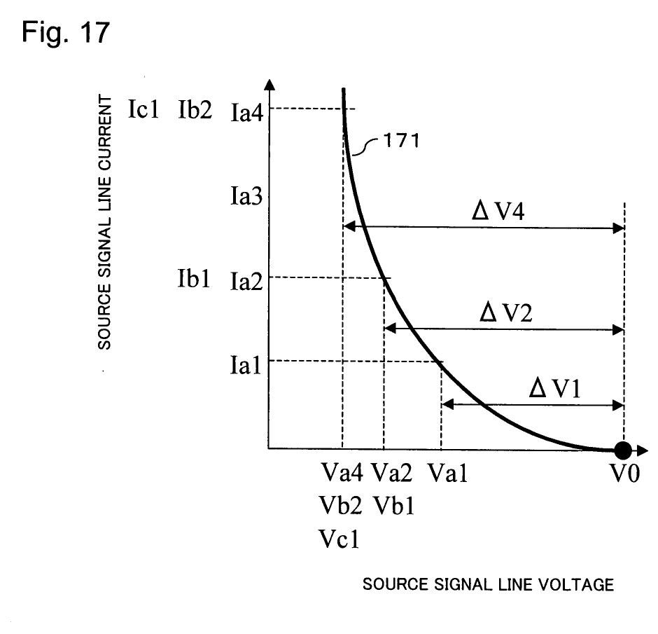

A cause of occurrence of a luminance change in the pixels, in which precharge is carried out, due to the change in the reference current will be explained with reference to FIG. 17.

FIG. 17 is a graph showing a relation of a source signal line current (on an ordinate) to a source signal line voltage (on an abscissa) in the circuit structure in FIG. 1 or 2. In FIG. 17, a voltage with respect to respective gradations at the time of onefold driving is Va and an electric current corresponding to the voltage is Ia. Numerals behind “a” correspond to the gradations. Similarly, the voltage and the current are Vb and Ib at the time of twofold driving and are Vc and Ic at the time of fourfold driving.

An example in which gradation 1 display is carried out in the next one horizontal scanning period of gradation 0 display will be explained.

In the gradation 1 at the time of the onefold driving, when it is assumed that a characteristic of the driving transistors 12 is indicated by a curve of 171, it is necessary to change a source signal line potential to a point of Va1 when an electric current with respect to the gradation 1 is Ia1. A potential change amount in this case is ΔV1.

As a principle for changing an electric current from a state of the gradation 0 to a state of the gradation 1 with current precharge, when a precharge current value is Ip, a precharge period is T1, and a source line capacitance is Cs, a source signal line potential change depends on Ip×T1/Cs. Ip and T1 are determined such that ΔV1 is equal to Ip×T1/Cs. (Ip is a maximum gradation current because output stages of a source driver are constituted as shown in FIG. 8. Ip is a current value at the time when a maximum gradation is outputted at the time of the onefold driving.)

When twofold current writing is carried out, an amount of potential change up to the gradation 1 requires a potential change equivalent to two gradations of the onefold driving. In the case of FIG. 17, the amount of potential change is ΔV2. When precharge is carried out in the same manner as the onefold driving, since a precharge current doubles, an amount of potential change is (2×Ip)−T1/Cs and ΔV2 is equal to 2×ΔV1. However, actually, the characteristic of the driving transistors 12 is in a nonlinear relation and ΔV2 is smaller than 2×ΔV1. Therefore, the potential change is larger than a predetermined value. As a result, an electric current increases and an image is displayed with high luminance.

In the gradation 2 display, similarly, when the current precharge representing the gradation 2 of the onefold driving (ΔV2=Ip×T2/Cs: T2 is a precharge period corresponding to the gradation 2) is directly applied, a potential change of the gradation 2 of twofold driving is excessively large and luminance increases.

As a method of solving this problem, there is a method of changing a precharge period (T1, T2, etc.) for each scale factor. It is necessary to set (the number of stages of precharge)×(the number of settings of scale factors) kinds of precharge periods. A size of a memory for data storage of a precharge pulse increases.

Thus, in the second embodiment of the present invention, a current value of the precharge current value Ip is changed according to a scale factor. Moreover, concerning a precharge period, a precharge period corresponding to a gradation converted into a current value at the time of the onefold driving is applied to always obtain a necessary amount of voltage change.

For example, in order to carry out the gradation 1 display at the time of the twofold driving, a precharge current value is set to ½ and a precharge period is set to a period corresponding to the gradation 2. As a result, an amount of potential change is (2×Ip)/2×T2/Cs=Ip×T2/Cs=ΔV2. Since the gradation 2 of the onefold driving and the gradation 1 of the twofold driving have the same amount of electric current, when the amount of potential change is equal to a potential change (ΔV2) for changing the gradation 1 at the time of the twofold driving to the gradation 2 at the time of onefold driving, this means that luminance is predetermined luminance.

In general, in order to carry out precharge in gradation M display at the time of N-fold driving, a precharge current value only has to be multiplied by 1/N and a precharge period only has to be set to a period equivalent to a gradation (N×M).

Concerning the precharge period, if a precharge period corresponding to the respective gradations at the time of the onefold driving is held, selection of the precharge period held only has to be changed in the case of the N-fold driving. It is unnecessary to hold a precharge period anew.

Concerning the precharge current value, in the above explanation, as shown in FIG. 8, when there are 255 gradations, only an electric current equivalent to the 255 gradations is fed. However, it is necessary to always fix a precharge current value. Since a current value per one gradation is multiplied by N, the number of gradations to be outputted is multiplied by 1/N to correspond to the current value.

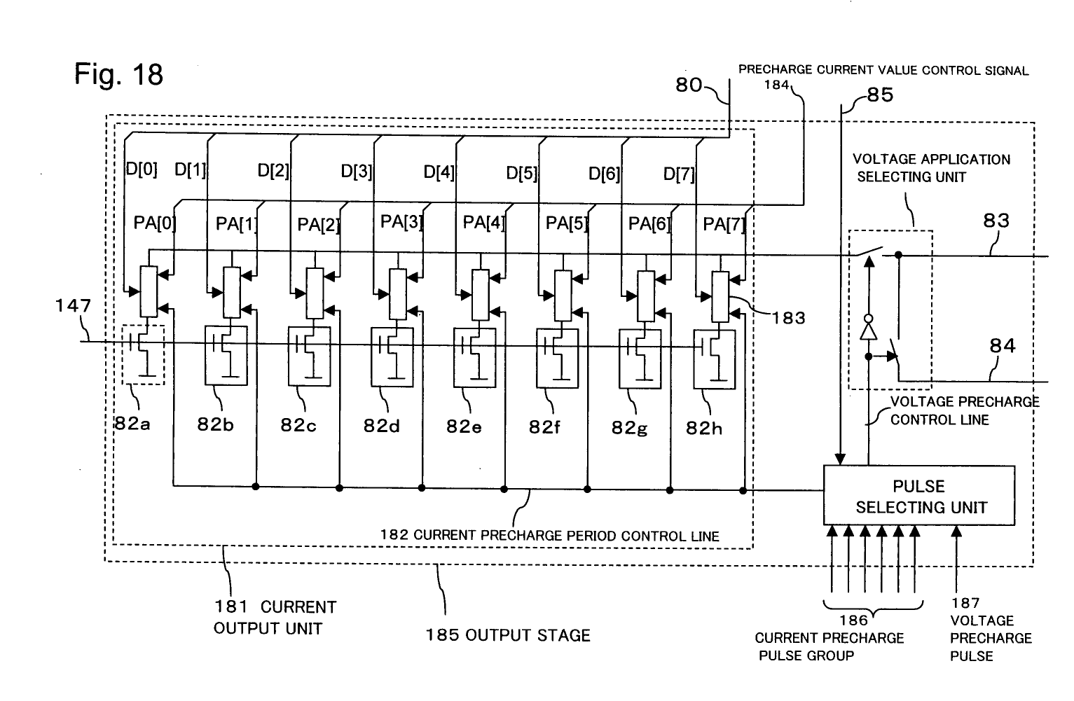

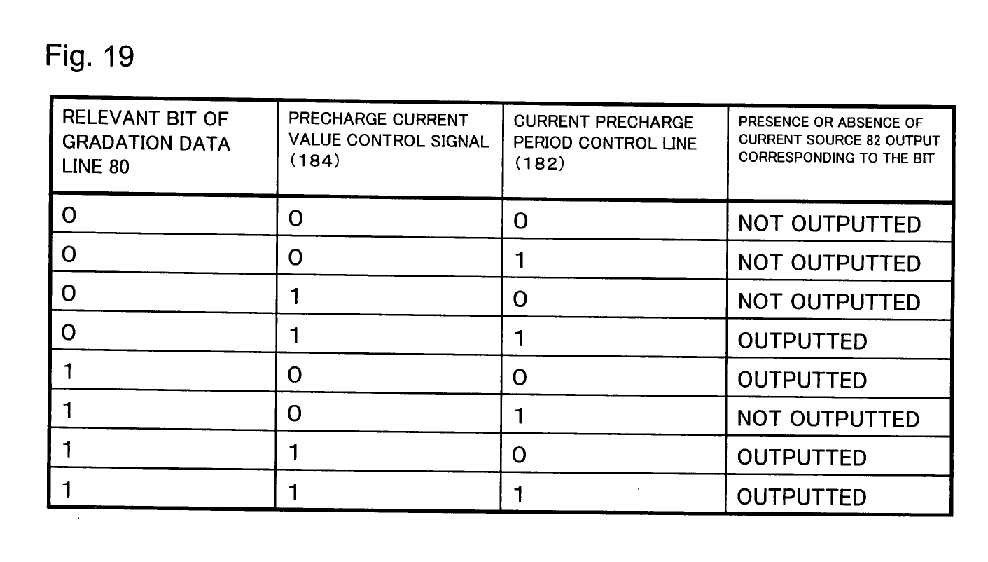

Thus, in the second embodiment of the present invention, as shown in FIG. 18, a precharge current value control signal 184 for controlling a current value for carrying out current precharge is provided anew. Even in a current precharge period, current output is performed only for gradations set by the precharge current value control signal 184. In periods other than the current precharge period, gradation current output is performed by a gradation data line 80. Therefore, the switching unit 183 that controls output of the current sources 82 operates as shown in FIG. 19.

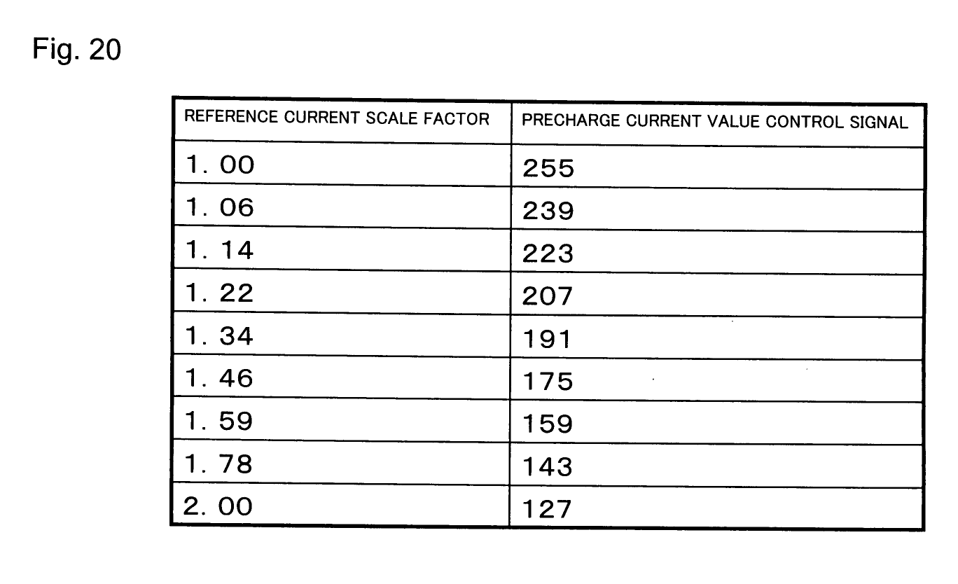

A method of fixing a precharge current using an output stage 185 shown in FIG. 18 is shown in FIG. 20. Since the precharge current value depends on a current value per one gradation×the number of gradations outputted, it is possible to fix a current value by multiplying the number of gradations by 1/N to offset an increase in the reference current multiplied by N.

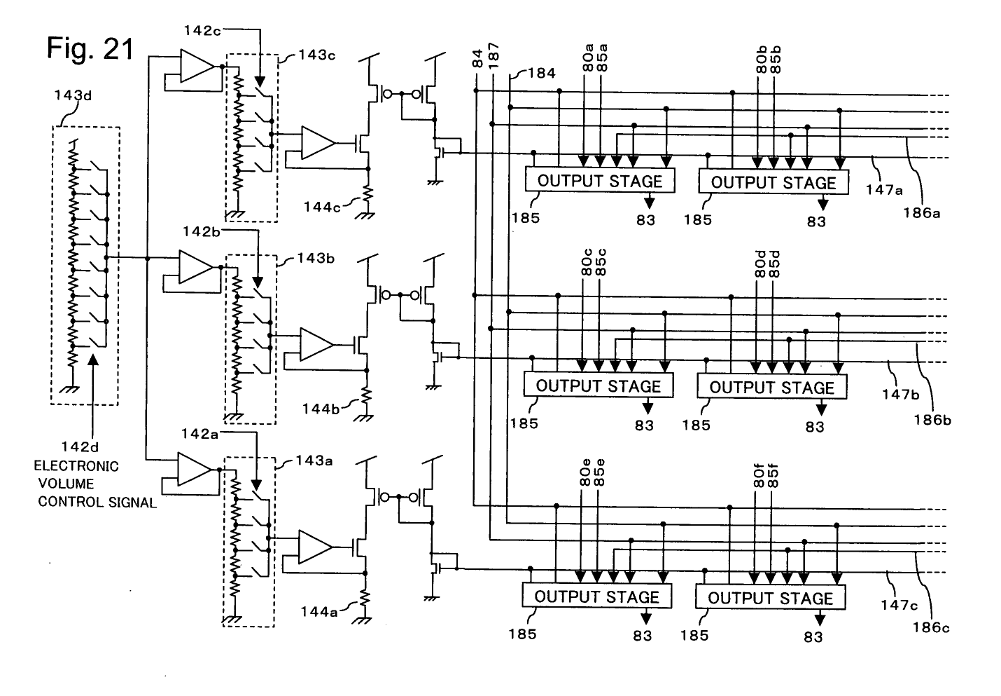

A structure of the output stage 185 having a function of changing the reference current and a precharge function is shown in FIG. 21. The precharge current value control signal 184 adopted in the second embodiment of the present invention is changed according to a scale factor of the reference current and changes a scale factor of an electric current for respective colors in common. Thus, the precharge current value control signal 184 is inputted to all output stages in common.

It is possible to realize, with a structure of a driver IC in FIG. 21, a function of fixing a precharge current value in order to optimize a precharge amount when the reference current is multiplied by N. A function of determining a precharge period corresponding to the multiplication by N is required. A circuit for realizing FIG. 20 is also required.

Thus, in the second embodiment of the present invention, in a controller unit, an input unit of a precharge judging unit is changed and a precharge current value generating unit is added.

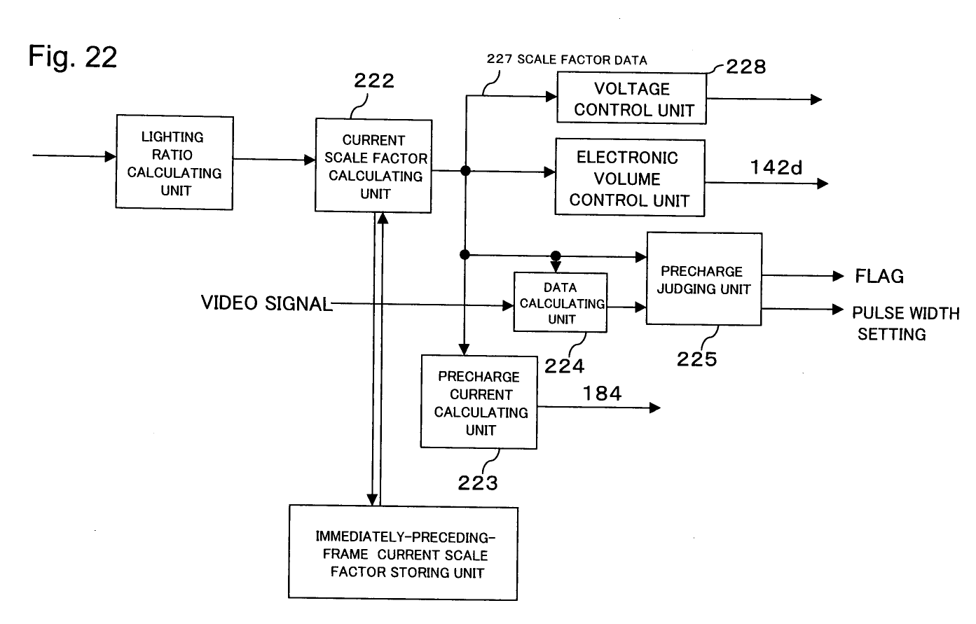

FIG. 22 is a diagram showing a structure of a judging circuit for changing the reference current according to a lighting ratio. The judging circuit shown in FIG. 22 includes a lighting ratio calculating unit, a current scale factor calculating unit 222, an immediately-preceding-frame current scale factor storing unit, a precharge current calculating unit 223, a voltage control unit 228, an electronic volume control unit, a precharge judging unit 225, and a data calculating unit 224.

In FIG. 22, a scale factor of the current scale factor calculating unit 222 is calculated on the basis of a lighting ratio calculated from a video signal. This scale factor is a reference current scale factor in FIG. 20. Therefore, first, the reference current is increased N-fold on the basis of this value. Scale factor data 227 is inputted to the electronic volume control unit to determine a value of the electronic volume 143d. The precharge current calculating unit 223 outputs the precharge current value control signal 184 on the basis of the scale factor data 227 such that output gradations are in the relation in FIG. 20 according to a scale factor. Since values of the precharge current value control signal 184 and the electronic volume control signal 142d are set according to a lighting ratio, a precharge current value always becomes a fixed value. (In FIG. 20, a value of a reference current scale factor×a precharge current value control signal is fixed in all the rows.)

A circuit structure for setting a precharge period will be explained. In order to carry out precharge in gradation M display at the time of N-fold driving, since the precharge period is set to a period equivalent to a gradation (N×M), the data calculating unit 224 multiplies gradation data by N in advance (N is a scale factor calculated by the current scale factor calculating unit 222) and the precharge judging unit 225 for generating a precharge flag corresponding to a gradation carries out judgment of precharge in the (N×M) gradation with respect to the input gradation M. Thus, the precharge period is equivalent to the (N×M) gradation.

This system has an advantage that it is possible to judge whether precharge should be performed and determine length of precharge without increasing a circuit size of the precharge judging unit 225. The length of precharge is as explained above. If precharge periods for respective gradation currents at the time of a onefold electric current are set regardless of a scale factor of the reference current, it is possible to set an optimum precharge period with respect to an arbitrary value of N.

Concerning the judgment on whether precharge should be carried out, precharge is necessary when it is impossible to change a source signal line potential to a predetermined gradation with an electric current corresponding to a display gradation. Time required for the change is represented by Δt=Cs×ΔV/Iw. (Cs: a source signal line capacitance, ΔV: an amount of voltage change from a source signal line state of an immediately preceding row to a source signal line state of the present row, Iw: a writing current value) It is difficult to write an electric current when a writing current value is small, that is, when a current value corresponding to a present display gradation is small or when a large potential change compared with a state of an immediately preceding row is necessary.

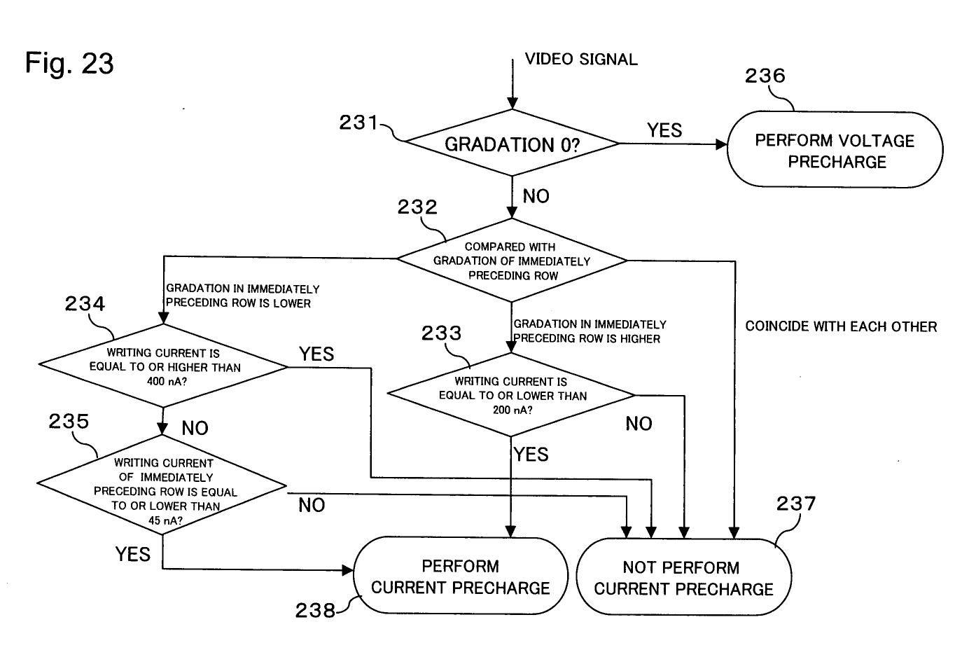

Thus, the judgment on whether precharge should be carried out is performed in accordance with a flow shown in FIG. 23. Since gradation 0 display can only be displayed by voltage precharge, first, it is judged whether a gradation is a gradation 0 (231) (an electric current at the time of the gradation 0 display is usually 0, it is ineffective to multiply the electric current by N because the electric current is still 0, and it is necessary to set a voltage corresponding to black display as voltage precharge applied to gate electrodes of driving transistors).

In the case of a gradation other than the gradation 0, the gradation is compared with a gradation of an immediately preceding row (232). When writing is carried out at a gradation identical with that of the immediately preceding row, a source line state does not change if there is no fluctuation in the transistors. Even if there is fluctuation, it is possible to change a source signal line to a predetermined value by multiplying the reference current according to the second embodiment of the present invention by N. Thus, precharge is not carried out (237).

When a writing current is larger in the immediately preceding row, as the present gradation is smaller, the writing current is smaller and an amount of potential change is larger. Therefore, it is judged whether a writing current value is equal to or smaller than a fixed value (e.g., 200 nA) (233). When the writing current value is equal to or smaller than the fixed value, precharge only has to be performed (238). When the writing current value is not equal to or smaller than the fixed value, precharge only does not have to be performed (237).

On the other hand, when writing current is smaller in the immediately preceding row, as the present gradation is larger, a writing current is larger, although an amount of potential change is larger. Judging from a general characteristic of the driving transistors 12, ΔV/Iw fluctuates according to a current value corresponding to a gradation of the immediately preceding row and a current value in the present row. When the current value in the present row is equal to or larger than a certain current value or when an electric current in the immediately preceding row is equal to or larger than a certain value, precharge only does not have to be performed (condition branches in 234 and 235).

In condition branches in 233, 234, and 235, it is difficult to perform judgment according to a current value. Condition branches according to a video signal gradation are necessary. A current value at the time of white display depends on a material efficiency and a panel structure. When the material and the panel are assembled as a module, a writing current value with respect to a video signal gradation is known. Therefore, when the module is mounted on a controller, a writing current value is judged according to whether a gradation is equal to or higher than a certain gradation.

When a writing current is multiplied by N, the, data calculating unit 224 multiplies data by N before the precharge judging unit 225 shown in FIG. 22. This makes it possible to cause the precharge judging unit 225 to operate uniformly regardless of a current scale factor. Therefore, this is advantageous in that it is unnecessary to increase a circuit size of the precharge judging unit 225.

For example, in the condition branch 233, when a gradation 10 at the time of the onefold driving is a writing current of 200 nA, precharge is performed at the gradation 10 or less. Since 200 nA at the time of the twofold driving is a gradation 5, precharge only has to be performed at the gradation 5 or less. In the constitution-of the second embodiment of the present invention, the condition branch 233 is not changed and a gradation of an input is doubled to cope with driving. Thus, the writing current is judged as the gradation 10 and precharged. Since it is possible to cope with N-fold driving without changing conditions of condition branches, it is suitable to provide a data calculating unit before the precharge judging unit 225 to multiply data by N as in the second embodiment of the present invention.

In the second embodiment of the present invention, the source driver has a function of changing a voltage value of the EL power supply 14b (FIG. 1 or 2) according to a scale factor of a writing current from a viewpoint of realizing reduction in electric power. Such as function is realized by the voltage control unit 228 in FIG. 22. In other words, the voltage control unit 228 changes a power supply voltage of the EL power supply 14b according to output data.

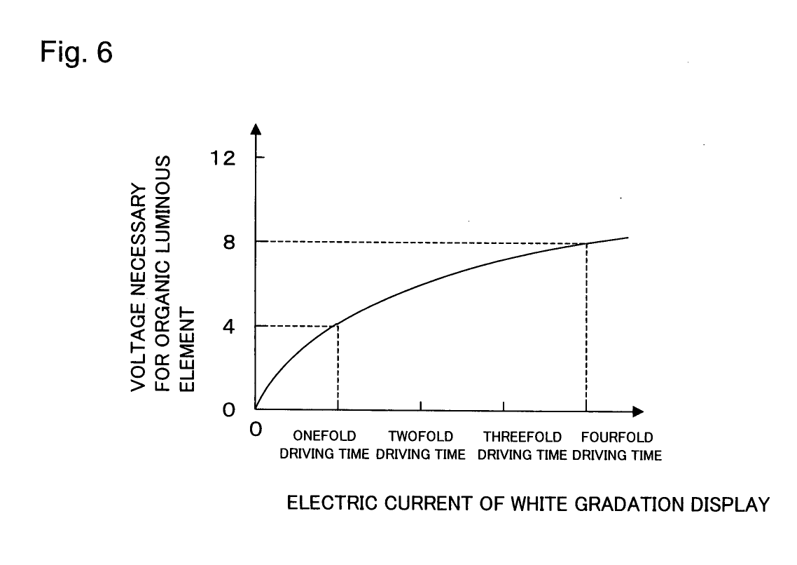

In FIG. 6, whereas a voltage necessary for an organic luminous element is 4V at the time of onefold driving, 8V is necessary at the time of fourfold driving. Thus, there is a difference of 4V of the necessary voltage. When a voltage of 4V is always excessively supplied to the EL power supply 14b, electric power equivalent to 4V×(a sum of electric currents flowing to the organic luminous element) increases.

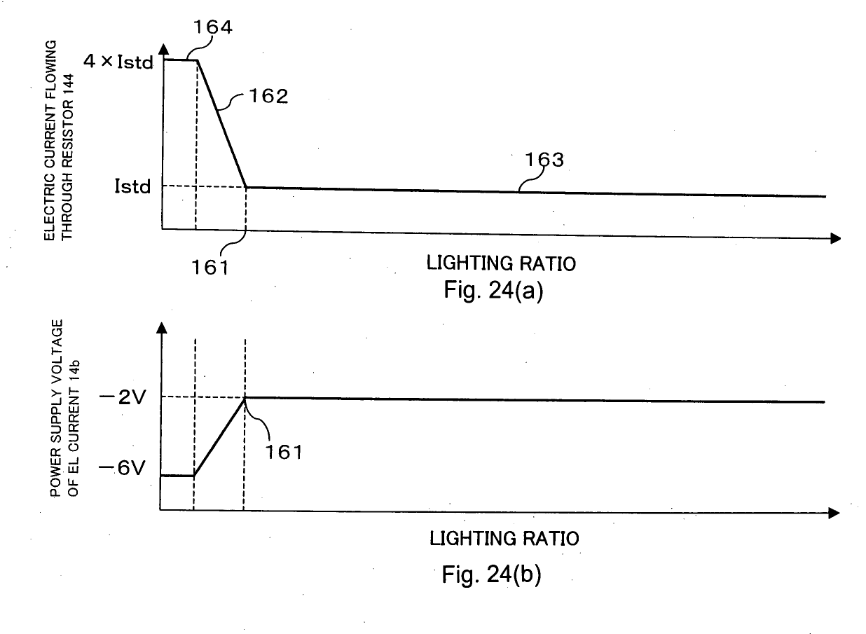

Thus, in the second embodiment of the present invention, for the purpose of supplying a necessary voltage to the EL power supply 14b according to a scale factor of a writing current, as shown in FIGS. 24(A) and 24(B), if a voltage is for example −2V at the time of the onefold driving, a voltage of −6V can be supplied at the time of the fourfold driving. Consequently, at a lighting ratio around 30% that frequently appears in a general video signal, there is no increase in electric power because a voltage at the EL power supply 14b is supplied at the same voltage equivalent to the onefold driving as that in the past. Writing only in a low lighting ratio area, where it is difficult to write an electric current, is given priority to increase the voltage at the EL power supply 14b. In this case, although electric power increases, a sum of electric currents flowing to the organic luminous element is small because the lighting ratio is low. Thus, an amount of increase in electric power is small.

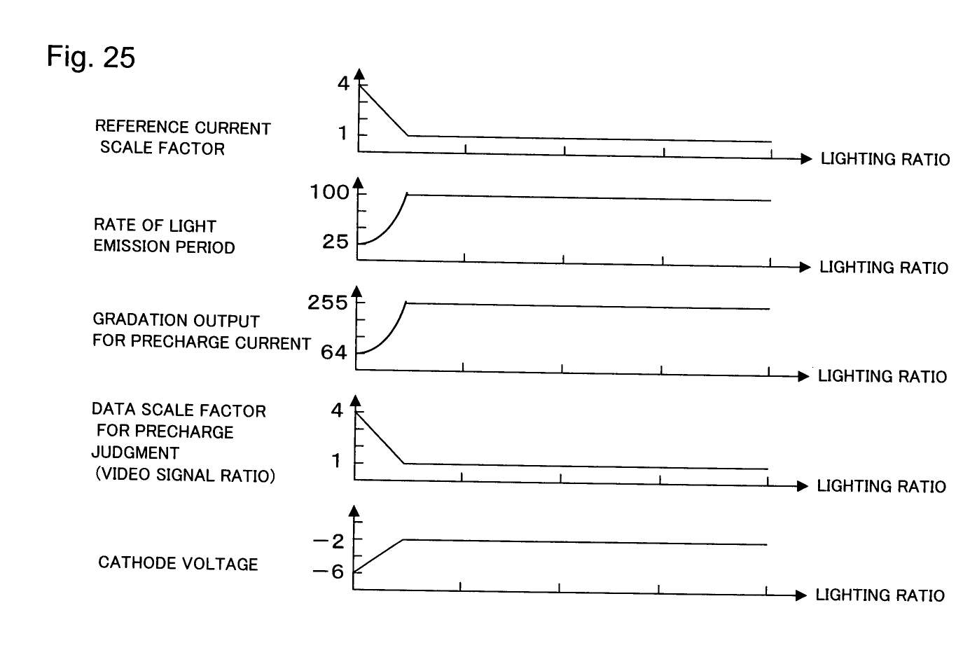

According to the second embodiment of the present invention, a scale factor of the reference current, a rate of a light emission period, the number of output gradations for a precharge current, a data scale factor for precharge judgment, and a cathode voltage change according to a lighting ratio. These factors change as shown in FIG. 25. This makes it possible to realize a display device in which display unevenness is reduced while an increase in electric power is controlled.

### Third Embodiment

A third embodiment of the present invention will be explained.

In the third embodiment, a case in which luminance of a display screen is changed according to command control using the source driver in the second embodiment will be explained.

If the source driver in the second embodiment of the present invention is used, it is possible to change a current value per one gradation at arbitrary timing. In the past, a light emission period is reduced in association with an increase in a current value. However, if the light emission period is fixed, it is possible to increase luminance. Since a current value can be changed by the electronic volume 143d in the structure shown in FIG. 21, it is possible to change luminance according to command control.

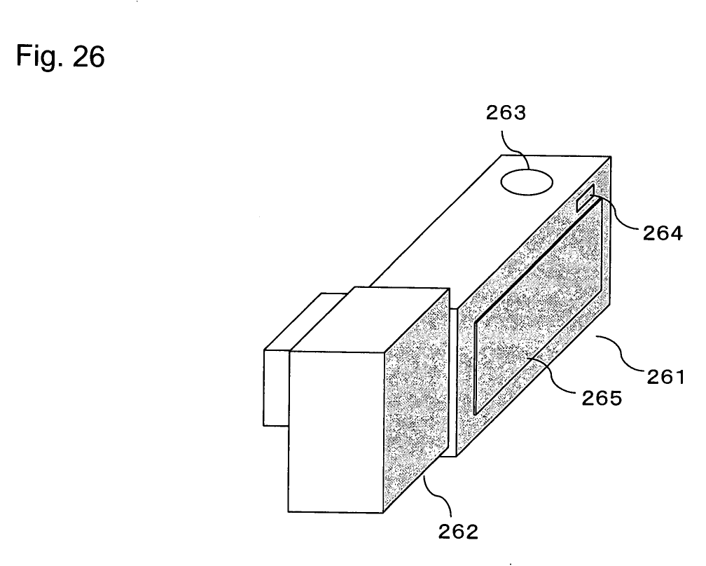

FIG. 26 is a diagram showing a digital camera including the display device according to the second embodiment of the present invention. A digital camera 261 includes a photographing unit 262, a shutter switch 263, a finder 264, and a display panel 265.

For example, in the digital camera shown in FIG. 26, it is possible to display imaging data at high luminance on the display panel 265 for a while after the shutter switch 263 is pressed. It is possible to cope with this display by increasing data of the electronic volume 143d to multiply an electric current by N when the shutter switch 263 is pressed. After a fixed period, if the display device is operated to return a value of the electronic volume 143d to an original value, the imaging data is displayed on the display panel 265 at predetermined luminance.

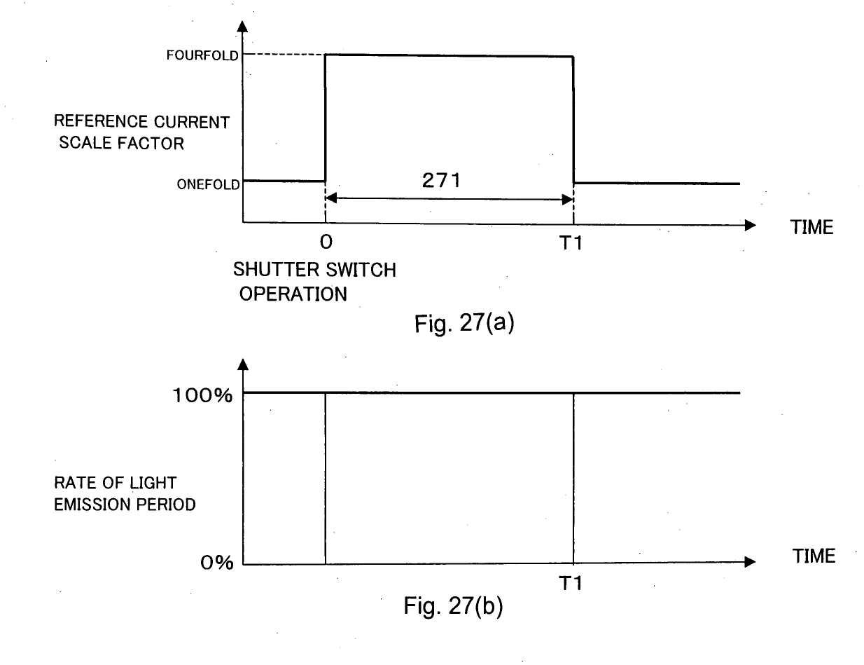

Changes in the electronic volume control signal 142d and a rate of a light emission period in response to operation of the shutter switch 263 are shown in FIG. 27. It is possible to display the imaging data at high luminance (fourfold luminance in this case) for a period of 271 in FIG. 27. In order to increase luminance only when it is desired to check content displayed on the display panel 265 and reduce electric power at normal time, it is possible to display the imaging data at predetermined luminance. In particular, since luminance can be controlled by an electronic volume, it is possible to easily set a ratio of increase of luminance and time for increasing luminance according to control by a microcomputer or the like on a command basis.

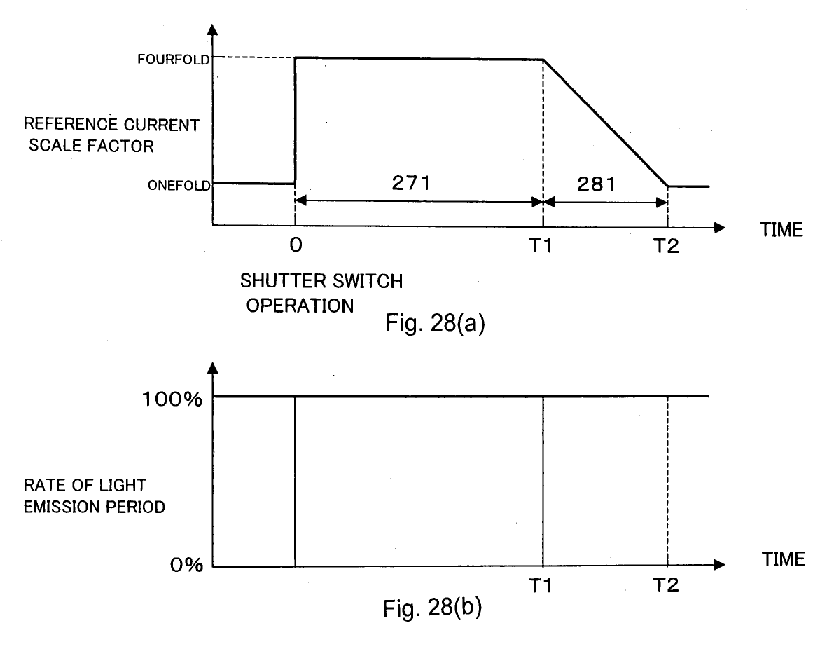

Since a current value can be changed in accordance with a stride of the electronic volume 143d, it is possible to gradually change the electronic volume control signal 142d and gradually change luminance. For example, it is also possible that, as shown in FIG. 28, luminance of the display panel 265 is increased from a moment when the shutter switch 263 is pressed and, after a fixed period (a period of 271 in FIG. 28), as indicated by a period of 281 in FIG. 28, luminance is gradually decreased to luminance before the shutter switch 263 is pressed.

If a current change function by the electronic volume 143d is used, it is also possible to change a luminance setting of the panel. In the conventional driver, since a setting of precharge deviates when the reference current is changed, only adjustment of a light emission period can be performed in luminance change. However, it is possible to change a current value itself by using the driver IC according to the second embodiment of the present invention. Thus, a way of changing luminance is diversified.

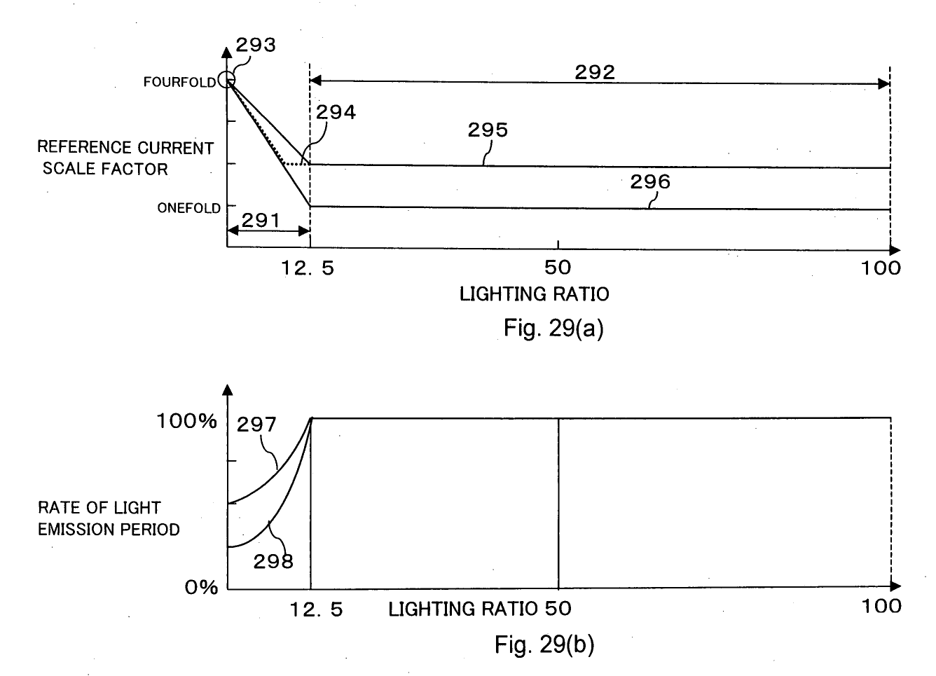

It is also possible to carry out the N-fold driving at a low lighting ratio and luminance adjustment in combination. Relations among a lighting ratio, a scale factor of a reference current, and a rate of a light emission period in the case in which a writing current is increased fourfold when a lighting ratio is low and in the case in which a writing current is increased fourfold than the case of the maximum normal luminance in a setting in which luminance is increased twofold are shown in FIGS. 29(A) and 29(B).

As characteristics of FIGS. 29(A) and 29(B), to cope with insufficiency of writing at the time of a low current, as indicated by a point 293, the scale factor of a reference current is fourfold both at the time of twofold luminance and at the time of onefold luminance. A difference of luminance is adjusted by the rate of a light emission period (297 and 298). In an area (291) where the lighting ratio is equal to or lower than 12.5%, thereference current is changed for the purpose of improvement of a writing characteristic. In an area where the lighting ratio is equal to or higher than 12.5%, a light emission period is 100%. A luminance difference is realized by the rate of a reference current. At normal luminance, driving is carried out with a onefold reference current and, at twofold luminance, driving is carried out with a twofold reference current.

It is possible to realize a display panel having both functions of improvement of a display characteristic at a low lighting ratio and a function of temporary luminance adjustment or luminance improvement by changing the reference current and the rate of a light emission period with respect to the lighting ratio as shown in FIGS. 29(A) and 29(B).

In the case of twofold luminance display, there is also a method of changing with a curve of 294 changing the scale factor of a reference current in the area of 291 in the same manner as the normal display. In this case, there is a larger merit in terms of electric power because it is possible to control an increase in an instant current flowing to the organic luminous element and further reduce a voltage at the EL power supply 14b. In the writing characteristic, a writing current is large compared with that at the time of normal display. Thus, concerning display unevenness, it is possible to realize an image quality higher than that in the normal display.

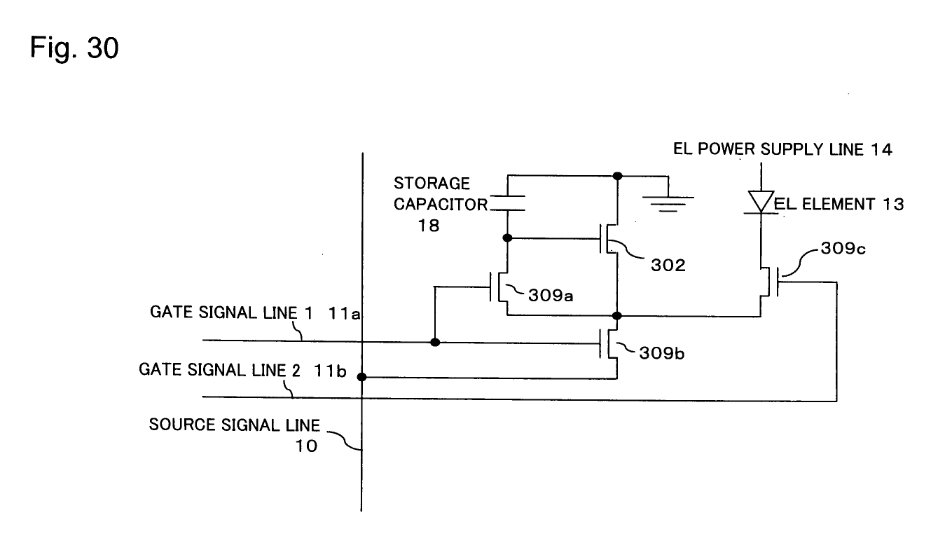

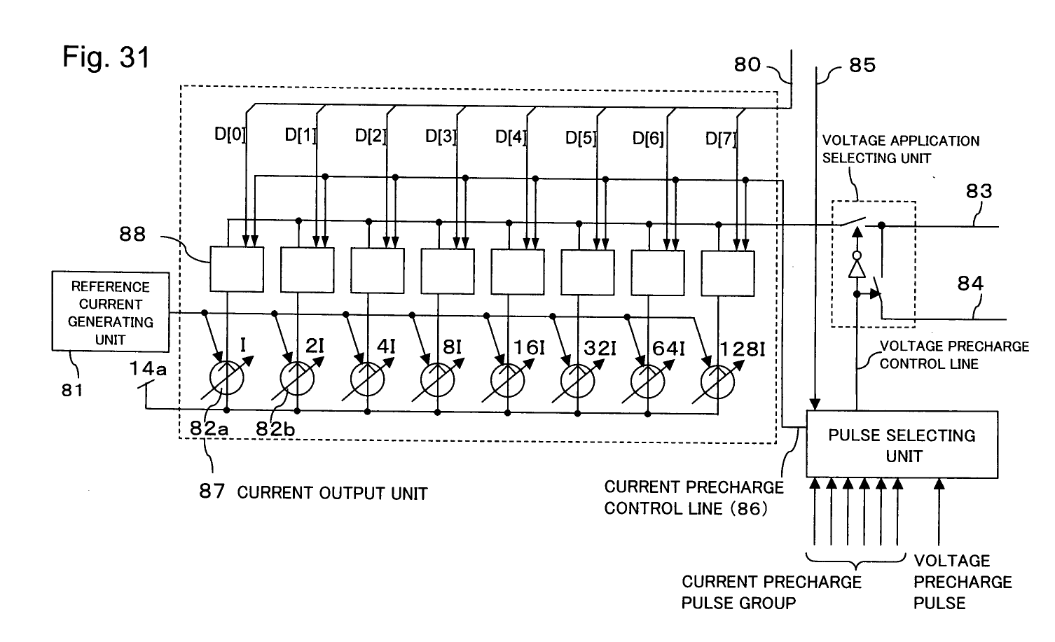

In the explanation of the first to the third embodiments, the current source of the source driver is the type for drawing an electric current from the outside and the pixel circuit is the p-type TFT. A circuit (FIG. 30) using a discharge type current source (FIG. 31) for a source driver and using an n-type TFT as a pixel circuit shows effects in the same manner. Differences are that an electric current flowing to the source signal line is reversed and magnitudes of voltages are opposite in white and black. The problem in that a potential fluctuates less easily when an electric current flowing to the source signal line is small is the same. Thus, when a writing current is increased N-fold, the circuit shows the same effects.

In the above explanation of the present invention, the transistors are the MOS transistors. However, the present invention is applicable in the same manner when the transistors are MIS transistors or bipolar transistors.

The present invention is applicable when the transistors are made of any material such as crystalline silicon, low-temperature polysilicon, high-temperature polysilicon, amorphous silicon, and gallium arsenide compound.

According to the driving method of a display device using an organic luminous element and the driving circuit of a display device using an organic luminous element according to the present invention, it is possible to control an increase in a circuit size to be lower even if the number of output bits of current drivers is increased. The present invention is useful for a driving method of a display device using an organic luminous element that drives a display device for performing gradation display according to an amount of electric current such as an organic electroluminescence element, a driving circuit of a display device using the organic luminous element, and the like.

What is claimed is:

1. A driving method of a display device using an organic luminous element that drives a display device using an organic luminous element, said driving device including,
at least one current source circuit that determines a current output per one gradation,
a current control unit that controls a current value of said current source circuit,
a lighting ratio calculating unit that calculates a lighting ratio of a full screen of a predetermined frame,
an immediately-preceding-frame current scale factor storing unit that stores a current scale factor of a frame immediately preceding said predetermined frame,
a current scale factor calculating unit that calculates an applied current scale factor corresponding to the lighting ratio calculated by said lighting ratio calculating unit, and
an electronic volume control unit that increases and decreases a current value applied according to a first applied current scale factor determined by said current scale factor calculating unit, said driving method of a display device using an organic luminous element comprising:
when a lighting ratio per one frame is lower than a predetermined value,
determining said first current scale factor with said current scale factor calculating unit; and
applying a predetermined electric current with said electric volume control unit, wherein
at a current scale factor in the case in which the lighting ratio per one frame is lower than the predetermined value, a current value N times, where N is a real number larger than 1, as large as that at the time of usual video display is applied.

2. The driving method of a display device using an organic luminous element according to claim 1, wherein said determining comprises: multiplying a gradation value indicated by a video signal in each frame by a predetermined value.

3. The driving method of a display device using an organic luminous element according to claim 1, wherein said determining comprises: multiplying a current value of a reference current source for each of display colors prepared for applying a video signal by a predetermined value simultaneously for the respective colors.

4. The driving method of a display device using an organic luminous element according to claim 1, wherein said predetermined lighting ratio is equal to or lower than 12.5%.

5. The driving method of a display device using an organic luminous element according to claim 1, wherein a scale factor of said predetermined current is larger than one and equal to or smaller than four.

6. The driving method of a display device using an organic luminous element according to claim 1, wherein an application time of a current signal to said organic luminous element at the time when a current value multiplied by N, which is said predetermined current scale factor, is applied to said organic luminous element constituting each pixel of the display device using said organic luminous element is represented as 1/N (t), which is 1(t) when N is 1.

7. The driving method of a display device using an organic luminous element according to claim 1, wherein
said display device using the organic luminous element includes:
at lest one current source circuit that determines a current output per one gradation;
a current control unit that controls a current value of said current source circuit;
a current scale factor calculating unit that multiplies an applied current scale factor; and
an electronic volume control unit that increases and decreases a current value applied according to a second applied current scale factor determined by said current scale factor calculating unit, and
said driving method of a display device using an organic luminous element includes:
applying, in a predetermined period, a predetermined electric current determined according to said second applied current scale factor; and
applying, after the predetermined period passes, a predetermined electric current determined according to said first applied current scale factor.

8. A driving method of a display device using an organic luminous element, said display device including,
at least one current source circuit that determines at least a current output per one gradation,
a current control unit that controls a current value of said current source circuit, and
a precharge unit that applies a predetermined electric signal before applying a video signal, precharge signal values corresponding to respective display gradations at the time of onefold driving, which is normal driving, being stored in said precharge unit,
said driving method of a display device using an organic luminous element comprising: using, in displaying a gradation M, where M is an integer equal to or larger than 0, with a current value applied to the display device using the organic luminous element set to N times, where N is a real number equal to or larger than 1, as large as that at the time of normal driving, a value calculated by multiplying said precharge signal stored by 1/N as a precharge current and carrying out precharge in a period calculated by multiplying a usual precharge period by N/M.

9. The driving method of a display device using an organic luminous element according to claim 7, wherein an electric signal for performing said precharge is an electric current.

10. The driving method of a display device using an organic luminous element according to claim 8, wherein an electric signal for performing said precharge is an electric current.

11. A driving circuit of a display device using an organic luminous element, comprising:
at least one current source circuit that determines a current output per one gradation;
a current control unit that controls a current value of said current source circuit;
a lighting ratio calculating unit that calculates a lighting ratio of a full screen in a predetermined frame;
an immediately-preceding-frame current scale factor storing unit that stores a current scale factor of a frame immediately preceding said predetermined frame;
a current scale factor calculating unit that calculates an applied current scale factor corresponding to the lighting ratio calculated by said lighting ratio calculating unit; and
an electronic volume control unit that increases and decreases a current value applied according to an applied current scale factor determined by said current scale factor calculating unit, wherein
the current scale factor calculating unit determines a current value N times, where N is a real number larger than 1, as large as that at the time of usual video display.
